(19) United States
(12) Patent Application Publication
(10) Pub. No.: US 2026/0159327 A1
(43) Pub. Date: Jun. 11, 2026

(54) AUGER WITH FIRST SECTION OF ROOT HAVING VARIABLE DIAMETER, SYSTEM, METHOD OF FILLING VESSELS AND METHOD OF COMMUNICATING PARTICULATE MATERIAL, THEREOF

(71) Applicant: Altria Client Services LLC, Richmond, VA (US)

(72) Inventor: Dwight D. WILLIAMS, Powhatan, VA (US)

(73) Assignee: Altria Client Services LLC, Richmond, VA (US)

(21) Appl. No.: 19/408,868

(22) Filed: Dec. 4, 2025

Related U.S. Application Data
(60) Provisional application No. 63/729,353, filed on Dec. 7, 2024.

(51) Int. Cl. B65G 33/14; B65B 1/12; B65G 33/26; B65G 47/18

(52) U.S. Cl. CPC B65G 33/14; B65B 1/12; B65G 33/265; B65G 47/18

(57) ABSTRACT

The auger includes a root in the shape of a first cylindrically-shaped post, a first section of the root having a variable diameter along a first longitudinal length of the first section, a second section of the root having a first uniform diameter along a second longitudinal length of the second section, and flights extending from the root, the flights being helically wound around the root along a third longitudinal length of the root.

### CROSS-REFERENCE TO RELATED APPLICATION

This application claims the priority benefit of U.S. Provisional Application No. 63/729,353, filed on Dec. 7, 2024, the entire contents of which are incorporated herein by reference in their entirety.

### BACKGROUND

### Field

Example embodiments generally relate to an auger for conveying particulate material.

### Description of Related Art

Augers can convey particulate material within a tube of a system during manufacturing of consumer products.

### SUMMARY

At least one example embodiment is directed toward an auger.

In at least one example embodiment, the auger includes a root in the shape of a first cylindrically-shaped post, a first section of the root having a variable diameter along a first longitudinal length of the first section, a second section of the root having a first uniform diameter along a second longitudinal length of the second section; and flights extending from the root, the flights being helically wound around the root along a third longitudinal length of the root.

In at least one example embodiment, the flights have a pitch and a first external diameter that is uniform along the third longitudinal length of the root.

In at least one example embodiment, the auger further includes a shank connected to the first section, the shank having an outer surface that is substantially smooth and is in the shape of a second cylindrically-shaped post with a second uniform diameter along a fourth longitudinal length of the shank, a first longitudinal centerline of the shank and a second longitudinal centerline of the root being collinearly aligned.

In at least one example embodiment, the flights have a first external diameter that is equal to a second external diameter of the shank.

In at least one example embodiment, the outer surface of the shank defines a notch on a first end of the shank, a second end of the shank being directly connected to the first section, the first end and the second end being opposite ends of the shank.

In at least one example embodiment, the first section of the root includes a first part with a first vertical cross-section that includes arcuate-shaped concave outer surfaces, and a second part with a second vertical cross-section that includes arcuate-shaped convex outer surfaces, the first part being between and directly connected to the second part and the second section.

In at least one example embodiment, an outer surface of the root includes a first neck that is between a first transition and a second transition, the first transition being at a first interface between the first section and the second section, the second transition being at a second interface between the first part and the second part.

In at least one example embodiment, the first neck has a first diameter that is a smallest diameter of root.

In at least one example embodiment, the auger further includes a shank connected to the first section of the root, wherein the root includes a second neck on a third end of the second part, the third end being directly connected to the shank, the second neck having a second diameter that is larger than the first diameter.

In at least one example embodiment, the shank has a first outer surface that is substantially smooth and is in the shape of a second cylindrically-shaped post with a second uniform diameter along a fourth longitudinal length of the shank, a first longitudinal centerline of the shank and a second longitudinal centerline of the root being collinearly aligned.

In at least one example embodiment, a second outer surface of the auger defines a step between the second neck and the shank.

In at least one example embodiment, the root includes a protrusion with a first diameter, the protrusion being within the second part, the first diameter being a largest diameter of the root.

In at least one example embodiment, the root at the second transition has a second diameter that is between 40% and 65% that of the first diameter.

In at least one example embodiment, the first neck has a third diameter that is a smallest diameter of root, the third diameter being half the size of the first diameter.

In at least one example embodiment, the flights have a first external diameter that is equal to the first diameter.

In at least one example embodiment, the first part and the second part are in the shape of a flattened sinusoidal curve.

In at least one example embodiment, the first part and the second part are in the shape of a curve that is formed by b-spline functions.

In at least one example embodiment, the first part and the second part are in the shape of a curve that is formed by b-spline functions using at least four control points.

At least one example embodiment is directed toward a system.

In at least one example embodiment, the system includes at least one first conveying tube; an auger including a root in the shape of a first cylindrically-shaped post, a first section of the root having a variable diameter along a first longitudinal length of the first section, a second section of the root having a first uniform diameter along a second longitudinal length of the second section; and flights extending from the root, the flights being helically wound around the root along a third longitudinal length of the root, the auger being within the at least one first conveying tube; and a hopper with a loading zone in communication with the at least one first conveying tube, the first section of the root being at least partially aligned with and directly underneath the loading zone.

In at least one example embodiment, the first section of the root includes a first part with a first vertical cross-section that includes arcuate-shaped concave outer surfaces, and a second part with a second vertical cross-section that includes arcuate-shaped convex outer surfaces, the first part being between and directly connected to the second part and the second section, an outer surface of the root includes a first neck that is between a first transition and a second transition, the first transition being at a first interface between the first section and the second section, the second transition being at a second interface between the first part and the second part, the first neck having a first diameter that is a smallest diameter of root.

In at least one example embodiment, the root includes a protruding portion with a second diameter, the protruding portion being within the second part, the second diameter being a largest diameter of the root, and the protruding portion being aligned with an entrance end of the loading zone.

In at least one example embodiment, the first longitudinal length plus the second longitudinal length is equal to the third longitudinal length.

In at least one example embodiment, the third longitudinal length spans across the first longitudinal length of the first section and the second longitudinal length of the second section.

At least another example embodiment is directed toward a method of making a system.

In at least one example embodiment, the method includes inserting an auger into a conveying tube; positioning a hopper above the conveying tube; and defining a slot within the conveying tube, the slot allowing the hopper to be in communication with an interior of the conveying tube, the auger including a root in the shape of a first cylindrically-shaped post, a first section of the root having a variable diameter along a first longitudinal length of the first section, a second section of the root having a first uniform diameter along a second longitudinal length of the second section, a portion of the first section being aligned and directly below at least an entrance end of the slot, and flights extending from the root, the flights being helically wound around the root along a third longitudinal length of the root.

In at least one example embodiment, the method further includes operatively arranging a motor to selectively rotate the auger in a rotational direction that communicates a particulate material in a first direction within the conveying tube, the first direction being toward an exit end of the slot, the exit end and the entrance end being on opposing ends of the slot.

In at least one example embodiment, the particulate material includes a powder.

In at least one example embodiment, the powder includes at least one active ingredient.

In at least one example embodiment, the at least one active ingredient includes tobacco-derived nicotine, the at least one active ingredient being in a pure form or a salt form.

In at least one example embodiment, the powder includes at least one excipient, the at least one excipient including at least one of an artificial sweetener, a salt, or a sugar alcohol.

In at least one example embodiment, the powder includes the salt, and the salt is also an active ingredient.

In at least one example embodiment, the salt is nicotine bitartrate.

In at least one example embodiment, the powder includes the salt, and the salt includes a buffer salt that includes sodium carbonate.

In at least one example embodiment, the powder includes the sugar alcohol, and the sugar alcohol is maltitol.

In at least one example embodiment, the at least one excipient includes a non-dissolvable filler material, the non-dissolvable filler material including microcrystalline cellulose.

At least another example embodiment is directed toward a method of filling vessels.

In at least one example embodiment, the method includes communicating particulate material in at least one first conveying tube in a first direction by rotating an auger in the conveying tube in a first rotational direction; and discharging the particulate material from the at least one first conveying tube into one or more vessels at a discharge point of the at least one first conveying tube, the auger including a root in the shape of a first cylindrically-shaped post, a first section of the root having a variable diameter along a first longitudinal length of the first section, a second section of the root having a first uniform diameter along a second longitudinal length of the second section, the second section extending away from the first section in the first direction, and flights extending from the root, the flights being helically wound around the root along a third longitudinal length of the root.

In at least one example embodiment, the one or more vessels includes a plurality of pouches.

In at least one example embodiment, the one or more vessels includes a plurality of consumer containers.

In at least one example embodiment, the flights have a pitch and a first external diameter that is uniform along the third longitudinal length of the root.

In at least one example embodiment, the method further comprises configuring the auger such that the first section of the root includes a first part with a first vertical cross-section that includes arcuate-shaped concave outer surfaces, and a second part with a second vertical cross-section that includes arcuate-shaped convex outer surfaces, the first part being between and directly connected to the second part and the second section.

In at least one example embodiment, the configuring configures such that an outer surface of the root includes a first neck that is between a first transition and a second transition, the first transition being at a first interface between the first section and the second section, the second transition being at a second interface between the first part and the second part.

In at least one example embodiment, the configuring configures such that the first neck has a first diameter that is a smallest diameter of root.

In at least one example embodiment, the configuring configures such that a shank is connected to the first section of the root, wherein the root includes a second neck on a third end of the second part, the third end being directly connected to the shank, the second neck having a second diameter that is larger than the first diameter.

In at least one example embodiment, the configuring configures such that the shank has a first outer surface that is substantially smooth and is in the shape of a second cylindrically-shaped post with a second uniform diameter along a fourth longitudinal length of the shank, a first longitudinal centerline of the shank and a second longitudinal centerline of the root being collinearly aligned.

In at least one example embodiment, the configuring configures such that a second outer surface of the auger defines a step between the second neck and the shank.

In at least one example embodiment, the configuring configures such that the root includes a protrusion with a first diameter, the protrusion being within the second part, the first diameter being a largest diameter of the root.

In at least one example embodiment, the configuring configures such that the root at the second transition has a second diameter that is between 40% and 65% that of the first diameter.

In at least one example embodiment, the configuring configures such that the first neck has a third diameter that is a smallest diameter of root, the third diameter being half the size of the first diameter.

In at least one example embodiment, the configuring configures such that the flights have a first external diameter that is equal to the first diameter.

In at least one example embodiment, the configuring configures such that the first part and the second part are in the shape of a flattened sinusoidal curve.

In at least one example embodiment, the configuring configures such that the first part and the second part are in the shape of a curve that is formed by b-spline functions.

In at least one example embodiment, the configuring configures such that the first part and the second part are in the shape of a curve that is formed by b-spline functions using at least four control points.

In at least one example embodiment, the particulate material includes a powder.

In at least one example embodiment, the powder includes at least one active ingredient.

In at least one example embodiment, the at least one active ingredient includes tobacco-derived nicotine, the at least one active ingredient being in a pure form or a salt form.

In at least one example embodiment, the powder includes at least one excipient, the at least one excipient including at least one of an artificial sweetener, a salt, or a sugar alcohol.

In at least one example embodiment, the at least one excipient includes a non-dissolvable filler material, the non-dissolvable filler material including microcrystalline cellulose.

At least one example embodiment is directed toward a method of communicating particulate material.

In at least one example embodiment, the method includes communicating particulate material in a conveying tube in a first direction by rotating an auger in the conveying tube in a first rotational direction, the auger including a root in the shape of a first cylindrically-shaped post, a first section of the root having a variable diameter along a first longitudinal length of the first section, a second section of the root having a first uniform diameter along a second longitudinal length of the second section, the second section extending away from the first section in the first direction, and flights extending from the root, the flights being helically wound around the root along a third longitudinal length of the root.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is an illustration of a conveying system, in accordance with at least one example embodiment;

FIG. 2 is an illustration of a close-up view of a part of the conveying system of FIG. 1, in accordance with at least one example embodiment;

FIG. 3 is an illustration of cross-sectional view (view III-III of FIG. 1) of another part of the conveying system of FIG. 1, in accordance with at least one example embodiment;

FIG. 4A is an illustration of cross-sectional view (view IV-IV of FIG. 1) of a portion of the conveying system of FIG. 1, in accordance with at least one example embodiment;

FIG. 4B is an illustration of cross-sectional view IV-IV of FIG. 1, shown without the particulate material, in accordance with at least one example embodiment;

FIG. 5 is an illustration of a cross-sectional view of a hopper of a conveying system, in accordance with at least one example embodiment;

FIG. 6 is an illustration of another cross-sectional view of a hopper of a conveying system, in accordance with at least one example embodiment;

FIG. 7 is an illustration of a perspective view of an auger, in accordance with at least one example embodiment;

FIG. 8 is an illustration of a side view of the auger of FIG. 7, in accordance with at least one example embodiment;

FIG. 9 is an illustration of another perspective view of the auger of FIG. 7, in accordance with at least one example embodiment;

FIG. 10 is an illustration of a perspective view of an end of the auger of FIG. 7, in accordance with at least one example embodiment;

FIG. 11 is an illustration of a cross-sectional view (view XI-XI of FIG. 8) of the auger of FIG. 7, in accordance with at least one example embodiment;

FIG. 12 is an illustration of a close-up view of a portion of the auger shown in FIG. 11, in accordance with at least one example embodiment;

FIG. 13A-13C are illustrations showing a formation of a curved profile used to define a root of the auger of FIG. 7, in accordance with at least one example embodiment;

FIG. 13D-13G are illustrations showing a formation of a curved profile used to define a root of the auger of FIG. 7, in accordance with at least one example embodiment;

FIG. 13H is an illustration showing a curved profile superimposed onto a tapered root section of an auger, in accordance with at least one example embodiment;

FIG. 13I is an illustration showing a travel path of particulate material flowing along the curved profile of the tapered root section of the auger, in accordance with at least one example embodiment;

FIGS. 13J-13M depict experimental data for the curved profiles, in accordance with at least one example embodiment;

FIG. 14 is an illustration of a conveying system, shown without particulate material, in accordance with at least one example embodiment;

FIG. 15 is an illustration of a conveying system, in accordance with at least one example embodiment; and

FIG. 16 is an illustration of method steps for a method of filling vessels, in accordance with at least one example embodiment.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

When the words “about” and “substantially” are used in this specification in connection with a numerical value, it is intended that the associated numerical value include a tolerance of +10% around the stated numerical value, unless otherwise explicitly defined.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

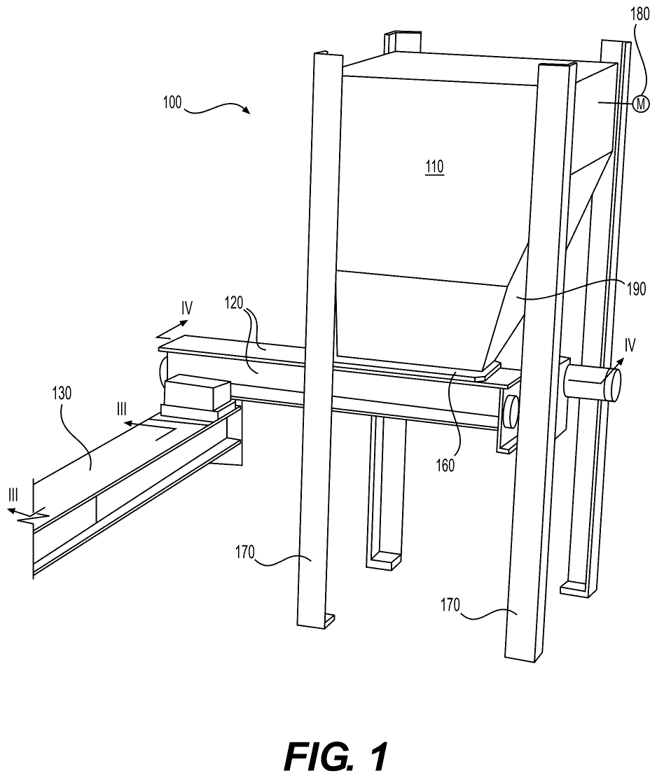

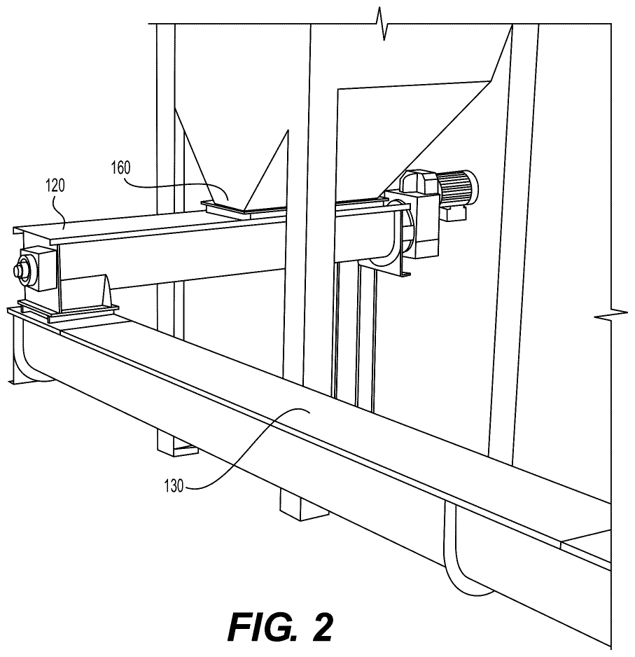

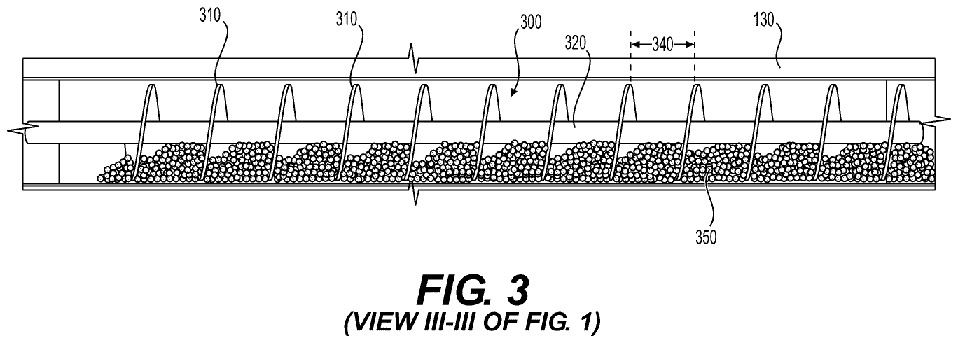

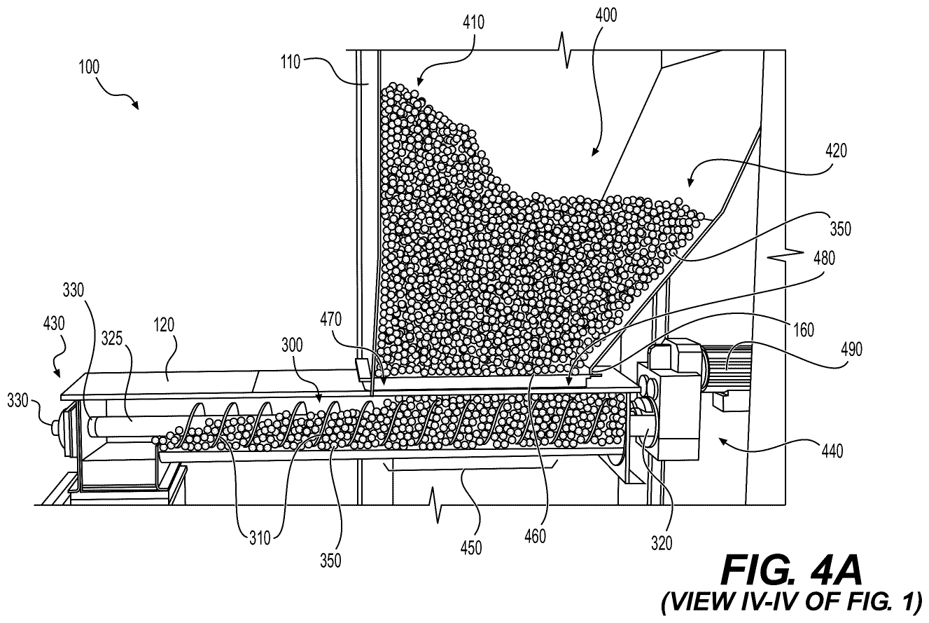

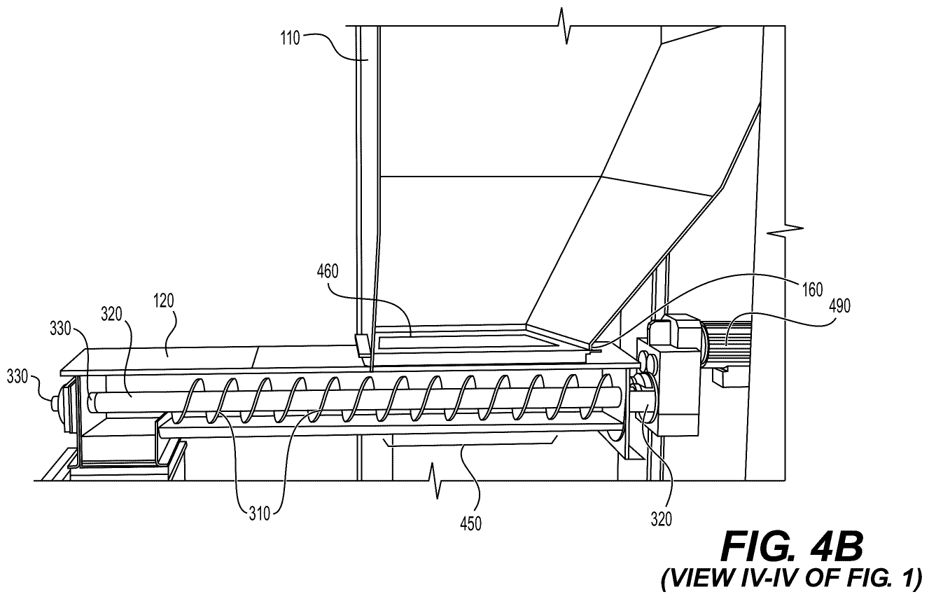

FIG. 1 is an illustration of a conveying system 100, in accordance with at least one example embodiment. FIG. 2 is an illustration of a close-up view of a part of the conveying system 100 of FIG. 1, in accordance with at least one example embodiment.

In at least one example embodiment, the conveying system 100 includes equipment for conveying material at a controlled rate. In at least one example embodiment, the conveying system 100 includes a hopper 110 that interfaces with one or more conveying tubes, as described herein. In at least one example embodiment, the hopper 110 is a storage container with one or more motors 180 that are operationally connected to the hopper 110 to facilitate a flow of the material within the hopper 110. In at least one example embodiment, the one or more motors 180 include vibratory motors for shaking the hopper 110 or portions of the hopper 110 to assist the material in flowing into a discharge 160 of the hopper 110. In at least one example embodiment, the hopper 110 includes one or more sloped walls 190 for assisting in funneling the material into and through the discharge 160 of the hopper 110. In at least one example embodiment, the hopper 110 includes legs 170, or other supports, which suspend the hopper 110 in an elevated position so that movement of the material is assisted by gravity, as the material is directed toward the discharge 160.

In at least one example embodiment, the system 100 includes one or more conveying tubes that convey the material away from the hopper 110. In at least one example embodiment, and as shown in FIG. 1, the system 100 includes a first conveying tube (first tube) 120 and a second conveying tube (second tube) 130. In at least one example embodiment, the first conveying tube 120 interfaces with the discharge 160 of the hopper 110 by collecting the material from the hopper 110 and conveying the material to the second conveying tube 130. In at least one example embodiment, the second conveying tube 130 can re-direct a direction of movement of the material to a desired location (a discharge point) for processing of the material, and/or for filling the material into containers and/or packaging, etc.

FIG. 3 is an illustration of cross-sectional view (view III-III of FIG. 1) of a part of the conveying system 100 of FIG. 1, in accordance with at least one example embodiment. FIG. 4A is an illustration of cross-sectional view (view IV-IV of FIG. 1) of a portion of the conveying system 100 of FIG. 1, in accordance with at least one example embodiment. FIG. 4B is an illustration of the cross-sectional view IV-IV of FIG. 1, shown without particulate material 350, in accordance with at least one example embodiment.

In at least one example embodiment, the first conveying tube 120 and/or the second conveying tube 130 includes an internal conveying element with structure that can transfer the material through the respective conveying tubes. In at least one example embodiment, the internal conveying element includes an auger 300, as shown in at least FIGS. 3-4B. In at least one example embodiment, the auger 300 includes a root 320. In at least one example embodiment, the root 320 is a substantially cylindrical-shaped rod, that may or may not have a common diameter along a length of the auger 300. In at least one example embodiment, the auger 300 includes flights 310 that are helically wound around the root 320. In at least one example embodiment, the flights 310 are sheet-like layers that are defined by the auger 300, which form a cork-screw structure around the root 320, where the flights 310 may rotate with a rotation of the root 320 to mobilize the material through the first conveying tube 120 and/or the second conveying tube 130. In at least one example embodiment, the flights 310 include a pitch 340 (spacing between flights), that may or may not be a common pitch 340 along a length of the auger 300.

In at least one example embodiment, and as shown in FIGS. 4A/B, a collar 330 can hold an end 325 of the auger 300. In at least one example embodiment, the collar 330 is located on a first end 430 of the first conveying tube 120, where the first end 430 opposes a second end 440 of the first conveying tube 120. In at least one example embodiment, a motor 490 is at the second end 440 of the first conveying tube 120, where the motor 490 interfaces with and imparts a rotational force on the auger 300 during an operation of the system 100. In at least one example embodiment, the collar 330 can be affixed to the auger 300 via a pin, a detent, a groove and slot, or other known structure that may be used to connect the auger 300 to the collar 330, where the collar 330 may rotate with the auger 300 and/or allow the auger 300 to freely rotate within the collar 330. In at least one example embodiment, the collar 330 freely rotates on an end of the first conveying tube 120. In at least another example embodiment, the collar 330 is stationary and does not rotate. In at least one example embodiment, the collar 330 does not exist, and instead an end of the auger 300 penetrates through a housing of the first conveying tube 120.

In at least one example embodiment, the material being conveyed within the system 100 is a solid, semi-solid, semi-liquid, or a gel material. In at least one example embodiment, the material is particulate material (particulate) 350. For the remainder of this document, the material will be referred to as “particulate material” 350, though it is to be understood that the material can include the other types of material described herein, wherein the elements of the system 100 are capable of mobilizing these other types of material, just as these elements are capable of mobilizing the particulate material 350.

In at least one example embodiment, the particulate material 350 is a powder, particles, balls, other solid or semi-solid matter, particulate that has been moistened with a high water content, etc. In at least one example embodiment, the particulate material 350 includes tobacco or a tobacco material. In at least one example embodiment, the particulate material 350 includes tobacco with a tacky material combined therewith. In at least one example embodiment, the particulate material 350 includes one or more materials for an oral product. In at least one example embodiment, the particulate material 350 includes a flavorant.

In at least one example embodiment, the particulate material 350 is a powder that includes at least one active ingredient. In at least one example embodiment, the powder is a dry granulated powder, or a “tacky” powder. In at least one example embodiment, the at least one active ingredient includes a tobacco-derived nicotine, where the at least one active ingredient is in pure form or salt form. In at least one example embodiment, the powder includes one or more excipients, an artificial sweetener, and/or salts. In at least one example embodiment, the one or more excipients include a non-dissolvable filler material such as a microcrystalline cellulose (MCC), and/or the one or more excipients include sugar alcohols such as maltitol. In at least one example embodiment, the salts include a buffer salt for pH adjustment, such as sodium carbonate. In at least one example embodiment, one or more of the salts are salts that are also an active ingredient, such as nicotine bitartrate.

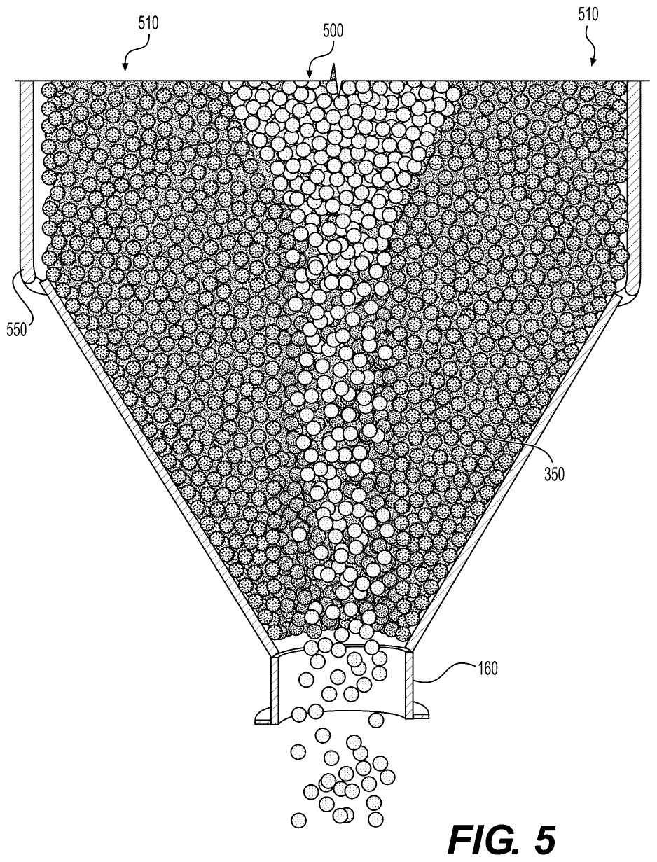

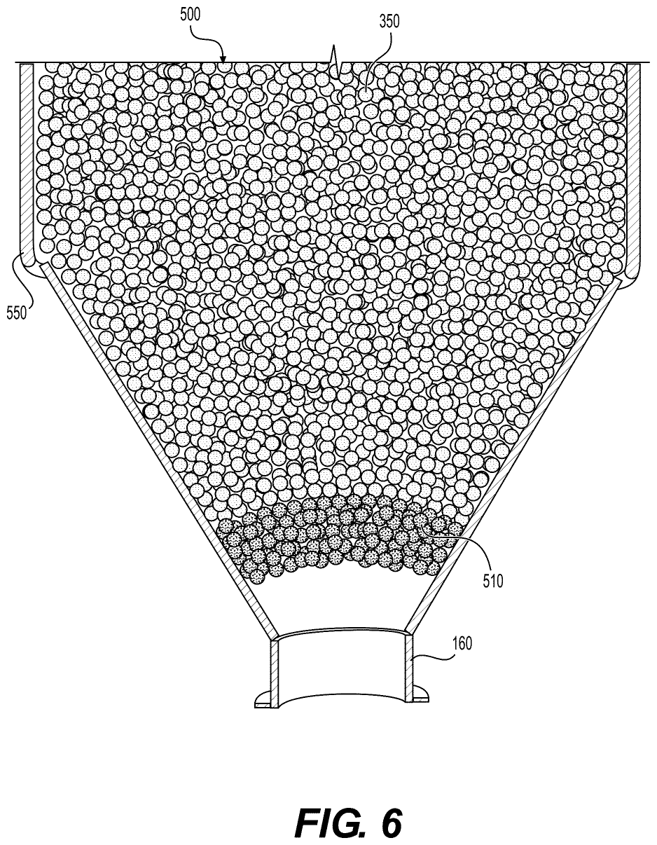

In at least one example embodiment, the powder has a varied particle size. In at least one example embodiment, the powder includes “fine” particles with a particle size (profile) that spans about 100 micrometers or less. In at least one example embodiment, the powder includes “large” particles with a particle size (profile) that spans a distance that is as large as 1.4 mm. In at least one example embodiment, the powder includes particle sizes that include the “fine” particles, the “large” particles, and particles with a size that is between “fine” and “large.” In at least one example embodiment, the powder includes particles with a particle size (profile) that spans across a range of about 10 micrometers to 1.44 mm, or about 200 micrometers to 500 micrometers, or about 300 micrometers to 400 micrometers. In at least one example embodiment, the particles of the powder are spherical and/or non-spherical in shape. In at least one example embodiment, the particles that are non-spherical have points, recesses and/or edges that reduce a flowability or the powder and promote “particle interlocking,” where this interlocking can cause “bridging” (discussed in relation to at least FIGS. 5 and 6), and can cause high avalanche angles within a hopper of a system (see the discussion of at least FIG. 4A).

In at least one example embodiment, the powder includes at least one flavorant. In at least one example embodiment, the at least one flavorant includes any of the flavorants and/or flavors described herein. In at least one example embodiment, the powder is a dry powder that is made to be “tacky,” due to an inclusion of the at least one flavorant. In at least one example embodiment, the powder that is “tacky” has low flowability properties.

In at least one example embodiment, a moisture content of the powder is about 2.0% to 4.5% by weight. In at least one example embodiment, the powder is relatively dry, with a moisture content of about 2.0% to 2.5% by weight. In at least one example embodiment, the powder is relatively moist, with a moisture content of about 4.0% to 4.5% by weight. In at least one example embodiment, the powder has a bulk density that is in a range of about 0.78 g/cc to 0.88 g/cc.

In some example embodiments, the tobacco material may include material from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

In at least one example embodiment, oral product may further include one or more elements such as a mouth-stable polymer, a mouth-soluble polymer, a sweetener (e.g., a synthetic sweetener and/or a natural sweetener), an energizing agent, (e.g., theanine and/or melatonin), a focusing agent (e.g., gingko biloba), a plasticizer, mouth-soluble or partially-soluble fibers (e.g., sugar beet fibers), an alkaloid, a mineral, a vitamin, a dietary supplement, a nutraceutical, a coloring agent, an amino acid, a chemesthetic agent, an antioxidant, a food-grade emulsifier, a pH modifier, a botanical (e.g., green tea), a tooth-whitening agent (e.g., sodium hexametaphosphate (SHMP)), a therapeutic agent, a processing aid, a stearate (e.g., magnesium and/or potassium), a wax (e.g., glycerol monostearate, propylene glycol monostearate, and/or an acetylated monoglyceride), a stabilizer (e.g., ascorbic acid and monosterol citrate, butylated hydroxytoluene (BHT), or butylated hydroxyanisole (BHA)), a lubricant (e.g., sodium lauryl sulfate (SLS)), a disintegrating agent, a lubricant, a preservative (e.g., sodium benzoate), a filler, a flavorant, an effervescent (e.g., carbon dioxide embedded in a flavorant or a filling material), flavor masking agents, a bitterness receptor site blocker, a receptor site enhancers, other additives, or any combination thereof. The oral product may include multiple additional elements. Additionally, a single element may belong to more than one of the categories above.

As used herein, the term “nutraceuticals” refers to any ingredient in foods that has a beneficial effect on human health. Nutraceuticals include particular compounds and/or compositions isolated from natural food sources and genetically modified food sources. Suitable nutraceuticals include, without limitation, various phytonutrients derived from natural plants and genetically engineered plants. The nutraceuticals can be included in an amount of about 0.1% to about 5% by weight based on the weight of the composition for human consumption.

In at least one example embodiment, the oral product may include the energizing agent. In at one example embodiment, the energizing agent includes caffeine, taurine, glucaronalactone, guarana, vitamin B6, vitamin B12, or any combination thereof.

Caffeine, also known as 1,3,7-trimethylxanthine, is a white, odorless, bitter tasting substance. Caffeine occurs naturally in tea, coffee, and chocolate, and is commonly added to soft drinks, energy drinks and some foods. However, because of the bitter taste of caffeine, the flavor of drinks or foods having a relatively high caffeine content can be unappealing. Caffeine may include synthetic caffeine and/or natural caffeine, such as coffee bean-extracted caffeine. In at least one example embodiment, the oral product includes caffeine in an amount greater than or equal to about 10 mg (e.g., greater than or equal to about 25 mg, greater than greater than or equal to about 150 mg) The caffeine may be included in an amount less than or equal to about 200 mg (e.g., less than or equal to about 150 mg, less than or equal to about 100 mg, less than or equal to about 75 mg, less than or equal to about 50 mg, or less than or equal to about 25 mg).

The compositions for human consumption have a relatively high caffeine content so as to provide a consumer with a burst of energy. Moreover, the compositions for human consumption contain about 50 mg to about 200 mg of caffeine or about 75 mg to about 175 mg of caffeine (e.g., 100 mg to about 150 mg of caffeine) so as to provide a burst of energy to the consumer. The composition provides a single serving of a food, drink, oral tobacco product or oral non-tobacco product. A single serving of food can have a weight of about 5 g to about 450 g. A single serving of drink is about 200 mL to about 600 mL. A single serving of an oral pouch product includes one oral pouch product formed as described herein.

Optionally, the composition for human consumption can also include additional energizing ingredients in addition to the caffeine complex. Suitable energizing ingredients include, without limitation, taurine, citicoline, and guarana. The energizing ingredients can be included in an amount of about 0.1% to about 5% by weight based on the weight of the composition for human consumption.

In at least one example embodiment, the soothing agent includes theanine, melatonin, or both theanine and melatonin. The soothing agent may also include, for example only, chamomile, lavender, jasmine, soursop, cannabidiol, or any combination thereof. The soothing agent can be added as a flavorant and or aroma embedded in the product and/or the package. The soothing agents can be included in an amount of about 0.1% to about 5% by weight based on the weight of the composition for human consumption.

In at least one example embodiment, the focusing agent includes Ginkgo biloba.

The at least one sensate or chemesthesis agent may include mint, menthol, cinnamon, pepper, jambu, or any combination thereof. The at least one sensate or chemesthesis agent may include any soothing, cooling, and/or warming agent. For example, in some example embodiments, the at least one sensate or chemesthesis agent may include capsaicin, pipeline, alpha-hydroxy-sanshool, and (8)-gingerole, which may be selected so as to provide a warm, tingling or burning sensation. In other example embodiments, the at least one sensate or chemesthesis agent may include menthol, menthyl lactate, WS-3 (N-Ethyl-p menthane-3-carboxamide), WS-23 (2-Isopropyl-N,2,3-trimethylbutyramide) and Evercool 180™ (available from Givaudan SA), which may be selected so as to provide a cooling sensation. The at least one sensate or chemesthesis agent may be included in an amount ranging from about 0.01% by weight to about 5% by weight based on the weight of the oral pouch product.

The antioxidant may include, for example, vitamin C, vitamin B, magnesium, calcium, or any combination thereof.

Suitable minerals include, without limitation, calcium, magnesium, phosphorus, iron, zinc, iodine, selenium, potassium, copper, manganese, molybdenum, chromium, and mixtures thereof. The amount of minerals incorporated into the composition for human consumption can be varied according to the type of mineral and the intended adult consumer. For example, the amount of minerals may be formulated to include an amount less than or equal to the recommendations of the United States Department of Agriculture Recommended Daily Allowances.

Amino acids can also be included in the composition for human consumption. Suitable amino acids include, without limitation, the eight essential amino acids that cannot be biosynthetically produced in humans, including valine, leucine, isoleucine, lysine, threonine, tryptophan, methionine, and phenylalanine. Examples of suitable amino acids include the non-essential amino acids including alanine, arginine, asparagine, aspartic acid, cysteine, glutamic acid, glutamine, glycine, histidine, proline, serine, and tyrosine. The amino acids can be included in an amount of about 0.1% to about 5% by weight based on the weight of the composition for human consumption.

In at least one example embodiment, the at least one functional ingredient may be included in an amount ranging from about 0.01% by weight to about 5% by weight based on the weight of the oral pouch product (e.g., about 0.1 wt. % to about 4.5 wt. %, about 1 wt. % to about 4 wt. %, about 1.5 wt. % to about 3.5 wt. %, about 2 wt. % to about 3 wt. %).

In at least one example embodiment, the particulate material 350 is used in the manufacture of chewing tobacco, pouches, other oral products, formulations, cigars, cigarettes, etc., where a controlled quantity of the particulate material 350 is desired during manufacturing.

In at least one example embodiment, the oral product is an oral tobacco product, an oral non-tobacco product, an oral cannabis product, or any combination thereof. The oral product may be in a form of loose material (e.g., loose cellulosic material), shaped material (e.g., plugs or twists), pouched material, tablets, lozenges, chews, gums, films, any other oral product, or any combination thereof.

The oral product may include chewing tobacco, snus, moist snuff tobacco, dry snuff tobacco, other smokeless tobacco and non-tobacco products for oral consumption, or any combination thereof.

Where the oral product is an oral tobacco product including a smokeless tobacco product, the smokeless tobacco product may include tobacco that is whole, shredded, cut, granulated, reconstituted, cured, aged, fermented, pasteurized, or otherwise processed. Tobacco may be present as whole or portions of leaves, flowers, roots, stems, extracts (e.g., nicotine), or any combination thereof.

In at least one example embodiment, the oral product includes a tobacco extract, such as a tobacco-derived nicotine extract, and/or synthetic nicotine. The oral product may include nicotine alone or in combination with a carrier (e.g., white snus), such as a cellulosic material. The carrier may be a non-tobacco material (e.g., microcrystalline cellulose) or a tobacco material (e.g., tobacco fibers having reduced or eliminated nicotine content, which may be referred to as “exhausted tobacco plant tissue or fibers”). In some example embodiments, the exhausted tobacco plant tissue or fibers can be treated to remove at least 25%, 40%, 50%, 60%, 70%, 75%, 80%, 85%, 90%, or 95% of the nicotine. For example, the tobacco plant tissue can be washed with water or another solvent to remove the nicotine.

In other example embodiments, the oral product may include cannabis, such as cannabis plant tissue and/or cannabis extracts. In at least one example embodiment, the cannabis material includes leaf and/or flower material from one or more species of cannabis plants and/or extracts from the one or more species of cannabis plants. The one or more species of cannabis plants may include Cannabis sativa, Cannabis indica, and/or Cannabis ruderalis. In at least one example embodiment, the cannabis may be in the form of fibers. In at least one example embodiment, the cannabis may include a cannabinoid, a terpene, and/or a flavonoid. In at least one example embodiment, the cannabis material may be a cannabis-derived cannabis material, such as a cannabis-derived cannabinoid, a cannabis-derived terpene, and/or a cannabis-derived flavonoid.

The oral product (e.g., the oral tobacco product, the oral non-tobacco product, or the oral cannabis product) may have various ranges of moisture. In at least one example embodiment, the oral product is a dry oral product having a moisture content ranging from 5% by weight to 10% by weight. In at least one example embodiment, the oral product has a medium moisture content, such as a moisture content ranging from 20% by weight to 35% by weight. In at least one example embodiment, the oral product is a wet oral product having a moisture content ranging from 40% by weight to 55% by weight.

Referring again to FIGS. 3 and 4A/B, in at least one example embodiment the motor 490 is capable of imparting a controlled rotational movement of the auger 300, which in turn can cause a controlled movement of the particulate material 350 within the first conveying tube 120 and/or the second conveying tube 130. In at least one example embodiment, and as shown in FIGS. 4A/B, a loading zone 450 of the system 100 includes a portion of the auger 300 that directly receives the particulate material 350 from a slot 460 (or other similar opening) of the hopper 110. In at least one example embodiment, and as shown in FIGS. 3 and 4A, as the particulate material 350 is transported by the auger 300, the particulate material 350 can settle toward a lower elevation of the conveying tubes 120/130, depending on a consistency of the particulate material 350, a rotational speed and a geometry of the auger 300, and tolerances (spacing) between the auger 300 and an inner surface of a housing of the conveying tubes 120/130. In at least one example embodiment, especially when a “flooded loading” of the auger 300 is used to load the particulate material 350 into the first conveying tube 120 (using the hopper 110, as shown in FIG. 4A), the particulate material 350 can potentially fill, or nearly fill, an entire chamber of the first conveying tube 120, particularly at or near an exit end 470 of the loading zone 450 of the system 100. In at least one example embodiment, the “flood loading” of the loading zone 450 can cause a level 400 within the hopper 110 to be uneven where a low level (a “rat-hole”) 420 can be experienced, especially at locations above an entrance end 480 of the loading zone 450.

In at least one example embodiment, and as shown in FIG. 4A, problems with the uneven loading of the auger 300 and/or the first conveying tube 120 can potentially occur due to the flights 310 of the auger 300 becoming jammed or fully flooded especially near the exit end 470 of the loading zone 450, where the flights 310 become less effective at mobilizing the particulate material 350. In at least one example embodiment, the uneven loading can cause “rat-holing” and/or “bridging” (see a detailed description in FIGS. 5 and 6), which may be identified due to the level 400 of the particulate material 350 in the hopper 110 being visibly uneven, with a high level (or “bulge”) 410 of the particulate material 350 forming especially above the exit end 470 of the loading zone. In at least one example embodiment, the uneven loading can occur especially due to the root 320 of the auger 300 having a uniform diameter (as discussed in more detail, herein).

In at least one example embodiment, and as described in more details in relation to FIGS. 5 and 6, uneven loading of the auger 300 can cause an uneven and/or uncontrolled amount of the particulate material 350 to be transported by the auger 300, which in turn can cause uneven and/or uncontrolled amounts of the particulate material 350 to be included in consumer products made from the particulate material 350.

FIG. 5 is an illustration of a cross-sectional view of a hopper 550 of a conveying system, in accordance with at least one example embodiment. FIG. 6 is an illustration of another cross-sectional view of the hopper of a conveying system, in accordance with at least one example embodiment.

In at least one example embodiment, “rat-holing” is depicted within the hopper 550 of FIG. 5, where the discharge 160 of the hopper 550 is relatively restricted and movement of the particulate material 350 is not even throughout the hopper 550. In at least one example embodiment, and in such a configuration, a flow-stream 500 of the particulate material 350 may flow more steadily through portions of the hopper 550, while non-flowing areas 510 of the hopper 550 do not allow the particulate material 350 to readily pass through the discharge 160, or the non-flowing areas 510 flow at a slower rate through the discharge 160.

In at least one example embodiment, and as shown in FIG. 6, other flow issues can occur at or near the discharge 160 of the hopper 550, due to “bridging.” In at least one example embodiment, “bridging” can occur as loading of the particulate material 350 onto the auger 300 may be delayed, and/or may be ineffective, where the non-flowing areas 510 can cause a “bridge” to form that may obstruct the flow-stream 500 from effectively passing through the discharge 160, or passing at a slow rate.

In at least one example embodiment, an uneven loading of the auger 300, either due to “rat-holing” (FIGS. 4A and 5) or “bridging” (FIG. 6), can cause an uncontrolled amount of the particulate material 350 to be loaded onto the auger 300 and transported through at least the first conveying tube 120.

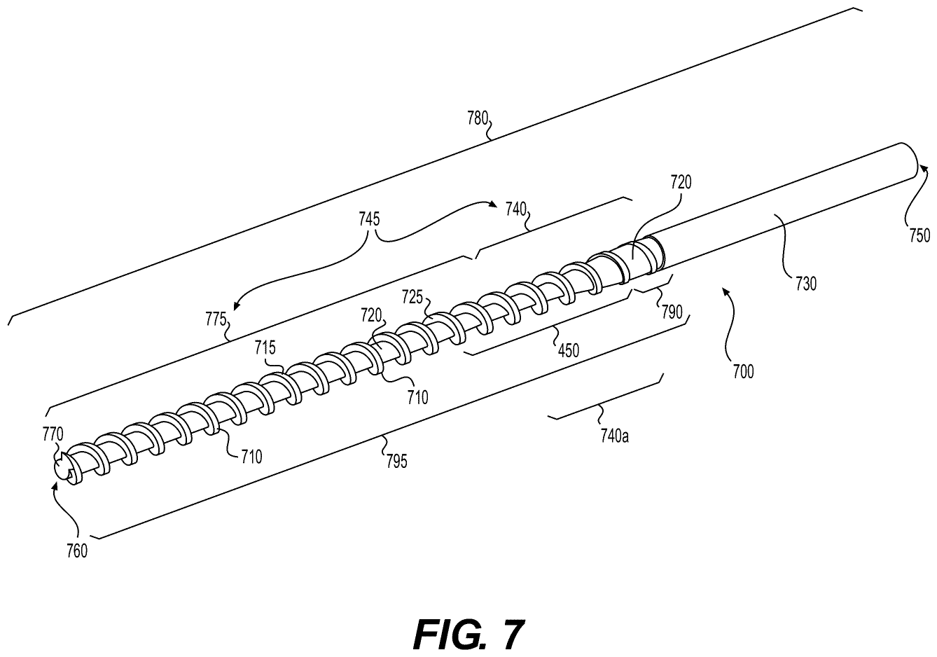

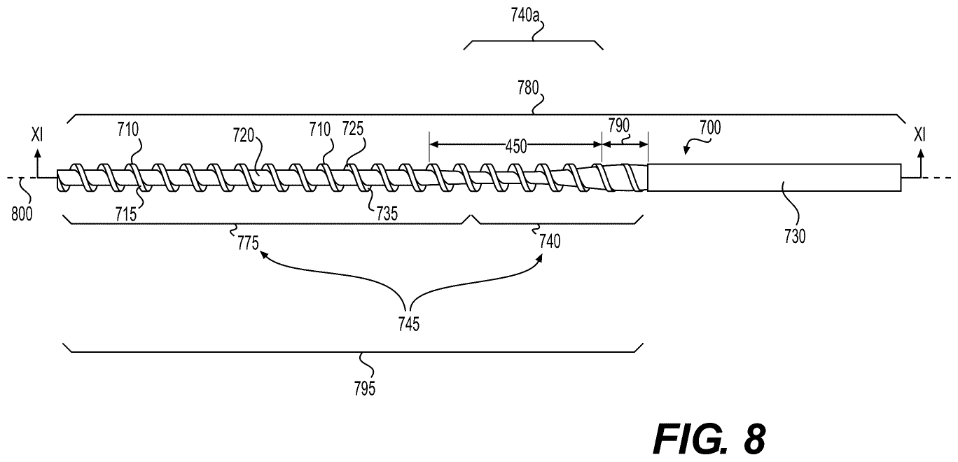

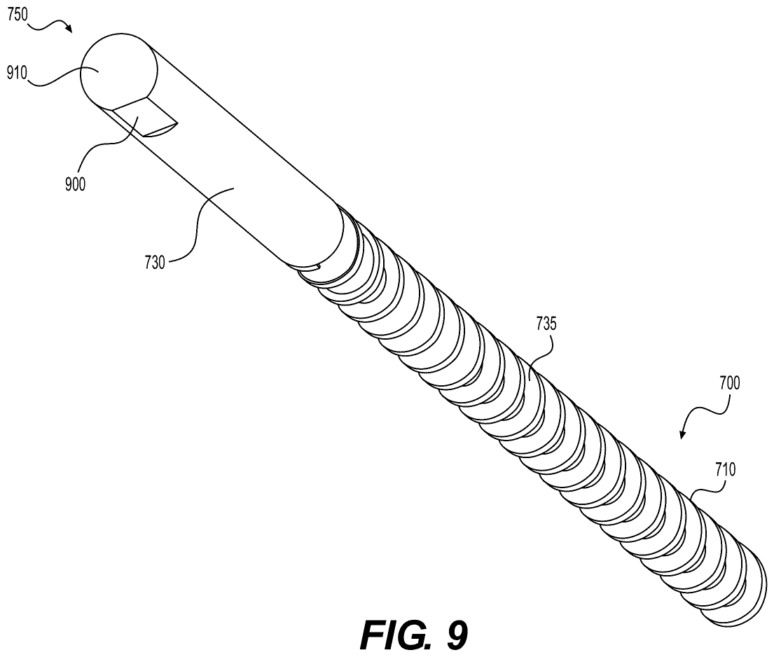

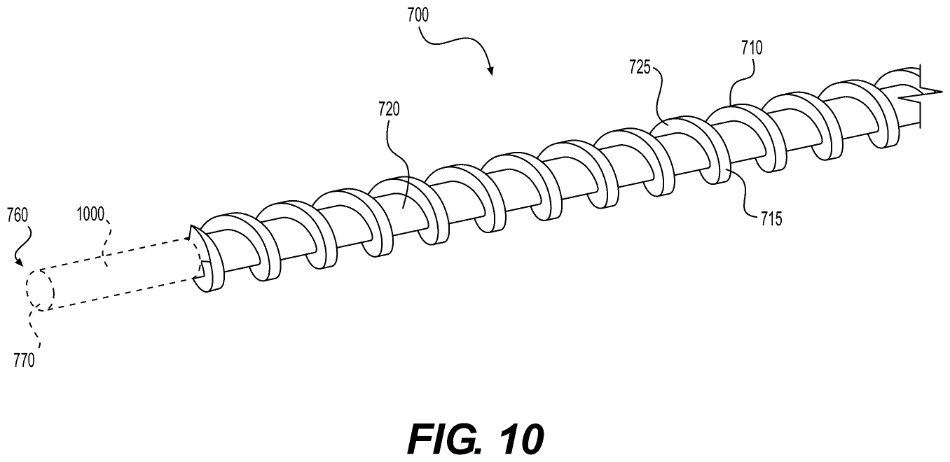

FIG. 7 is an illustration of a perspective view of an auger 700, in accordance with at least one example embodiment. FIG. 8 is an illustration of a side view of the auger 700, in accordance with at least one example embodiment. FIGS. 9-10 are illustrations of other perspective views of the auger 700, in accordance with at least one example embodiment.

In at least one example embodiment, the auger 700 has a substantially cylindrical shape along a longitudinal length 780 of the auger 700. In at least one example embodiment, the auger 700 includes a shank 730 on a first end 750 of the auger 700. In at least one example embodiment, the shank 730 is a substantially solid cylindrical shaft. In at least one example embodiment, a drive shaft 745 extends from the shank 730 on a second end 760 of the auger 700. In at least one example embodiment, the drive shaft 745 includes a root 720. In at least one example embodiment, the root 720 has a smaller diameter relative to the shank 730. In at least one example embodiment, the shank 730 and the root 720 are collinearly aligned, such that the shank 730 and the root 720 share a same longitudinal centerline 800.

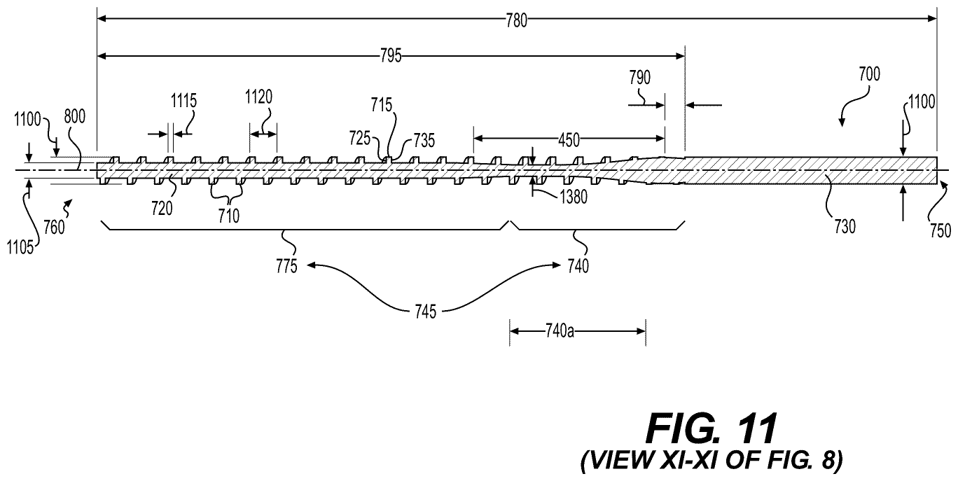

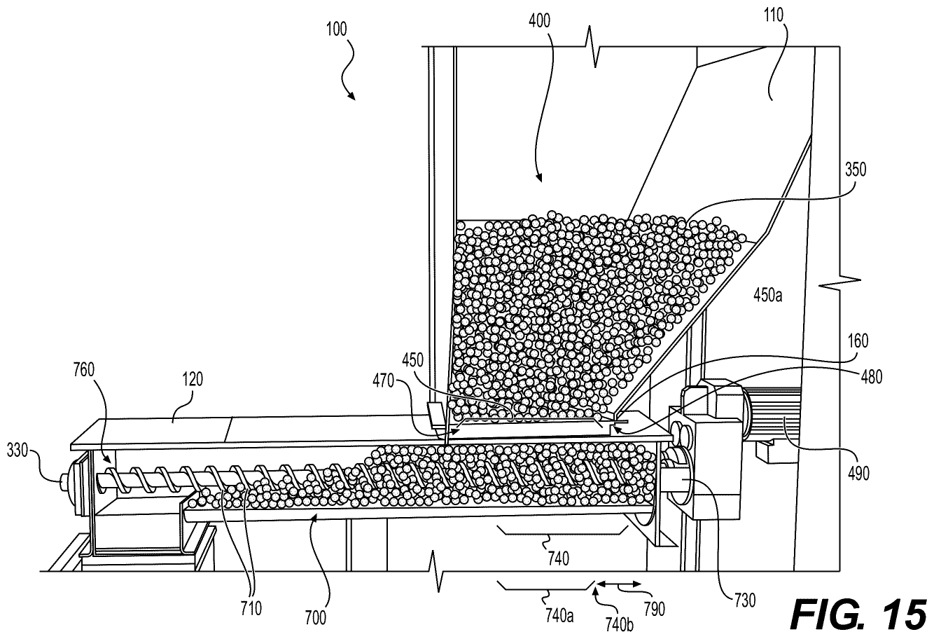

In at least one example embodiment, and as shown in FIGS. 7-8, flights 710 extend and are helically wrapped around the root 720 on the drive shaft 745 of the auger 700. In at least one example embodiment, the flights 710 are sheet-like layers that are defined by the auger 700, which form a “corkscrew” structure that is wound around the root 720 along a longitudinal length 795 of the drive shaft 745. In at least one example embodiment, the flights 710 include a first surface 725 (see FIGS. 7 and 10) and a second surface 735 (see FIG. 9) that are separated by an external radial surface 715. In at least one example embodiment, the flights 710 have a common (same) external diameter 1100 relative to the longitudinal centerline 800 of the auger 700 (see FIG. 11), as explained herein in more detail in relation to FIG. 11. In at least one example embodiment, the external radial surface 715 is a surface that spans from the first surface 725 to the second surface 735 of the flights 710, where the external radial surface 715 is perpendicular to the longitudinal centerline 800 of the auger 700, along the longitudinal length 795 of the drive shaft 745 (see FIG. 8). In at least one example embodiment, the first surface 725 is a leading surface of the auger 700, as the first surface 725 contacts and “pushes” the particulate material 350 when the auger 700 is in operational use (see FIG. 15). In at least one example embodiment, the second surface 735 is a lagging surface of the auger 700, as the second surface 735 helps divide the particulate material 350 into moveable portions that more effectively mobilize the particulate material 350 when the auger 700 is in operational use (FIG. 15).

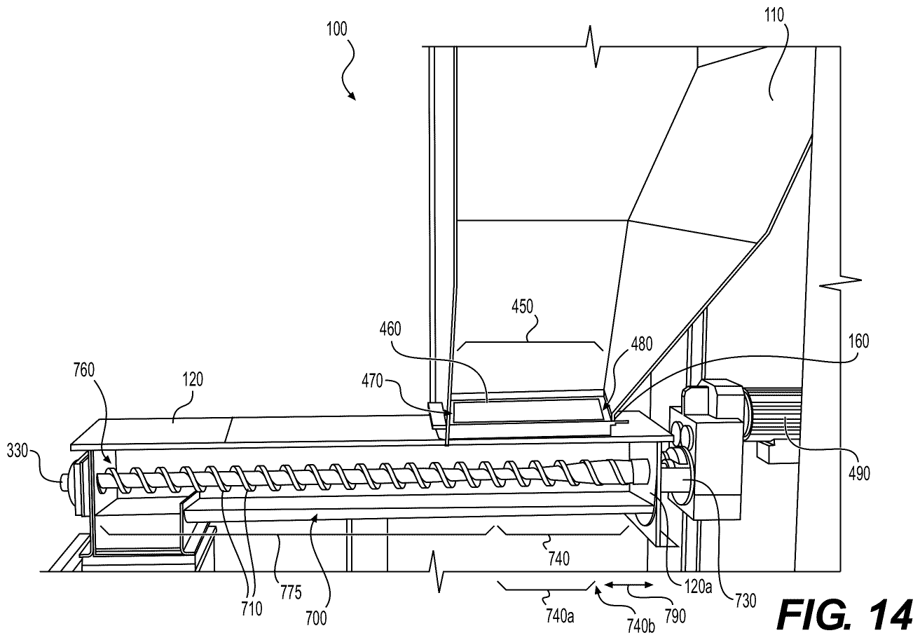

In at least one example embodiment, the drive shaft 745 includes a non-tapered root section 775 on the second end 760 of the auger 700. In at least one example embodiment, the root 720 of the non-tapered root section 775 has a common (same) root diameter 1105, as explained in more detail in FIG. 11. In at least one example embodiment, the non-tapered root section 775, or a majority of the non-tapered root section 775, is downstream of an expected location of the loading zone 450 (see at least FIGS. 11 and 14), when the auger 700 is installed in the system 100 for active use.

In at least one example embodiment, and as shown in at least FIGS. 7-8, the root 720 has a variable diameter along at least a portion of the longitudinal length 795 of the drive shaft 745. In at least one example embodiment, the drive shaft 745 includes a tapered root section 740 (a “variable diameter” root section) that is between the non-tapered root section 775 and the shank 730. In at least one example embodiment, the tapered root section 740 has a root diameter 1110 that varies along a longitudinal length of the tapered root section 740. In at least one example embodiment, the tapered root section 740 aligns with at least a portion of the loading zone 450 of the system 100 (see FIGS. 11 and 14). In at least one example embodiment, and as explained in more detail herein, the loading zone 450 of the system 100 discharges the particulate material 350 from the hopper 110 onto a loading portion 740a of the tapered root section 740 (see FIGS. 8 and 14), where a non-loading section 790 of the tapered root section 740 is to the side of the loading zone 450 and therefore does not directly receive the particulate material 350 from the loading zone 450 (see the detailed discussion in relation to FIGS. 14 and 15).

In at least one example embodiment, and as explained in more detail in relation to FIG. 14, the loading portion 740a of the tapered root section 740 is aligned with and spans across at least a portion of the loading zone 450 of the hopper 110, while the non-loading section 790 is to the side of the entrance end 480 of the loading zone 450 (see at least FIGS. 7-8 and 14). In at least one example embodiment, the loading portion 740a of the tapered root section 740 is aligned with and spans across over 50% of the length of the loading zone 450 of the system 100, including the entrance end 480 of the loading zone 450. In at least one example embodiment, the loading portion 740a is aligned with and spans across an entire length of the loading zone 450. In at least one example embodiment, the loading portion 740a is aligned with and spans across about 80% of the length of the loading zone 450, or about 70% of the length of the loading zone 450, or about 60% of the length of the loading zone 450, including being aligned with and directly underneath the entrance end 480 of the loading zone 450. In at least one example embodiment, the tapered root section 740 may or may not include the non-loading section 790. In at least one example embodiment, the auger 700 does not include the non-loading section 790, and instead the shank 730 directly abuts the loading portion 740a of the auger 700.

In at least one example embodiment, and as shown in FIGS. 7 and 10, the auger 700 can define a flat end 770 on the second end 760 of the auger 700. In at least another example embodiment, and as shown in FIG. 10, a solid shaft 1000 can be included on the second end 760 of the auger 700, where the solid shaft 1000 may interact with and slide into the collar 330 (see FIGS. 14-15). In at least one example embodiment, and as shown in FIG. 9, the first end 750 of the auger 700 can include a notch 900. In at least one example embodiment, the motor 490 of the system 100 can grip and turn the shank 730 by engaging the notch 900. In at least one example embodiment, a flat end 910 can be defined by the first end 750 of the auger 700.

In at least one example embodiment, the auger 700 is made from a material with a smooth and/or polished surface to prevent the particulate material 350 from adhering to the auger 700. In at least one example embodiment, the auger 700 is made from metal, coated metal material, food-safe plastic and/or a polymer. In at least one example embodiment, the auger 700 is made from stainless steel or carbon steel. In this example embodiment, the auger 700 is made from metal that is coated with a food-safe coating. In an example embodiment, the food-safe coating is made from a food-safe plastic or polymer material, or a polyether ether ketone (PEEK).

FIG. 11 is an illustration of a cross-sectional view (view XI-XI of FIG. 8) of the auger 700 of FIG. 7, in accordance with at least one example embodiment.

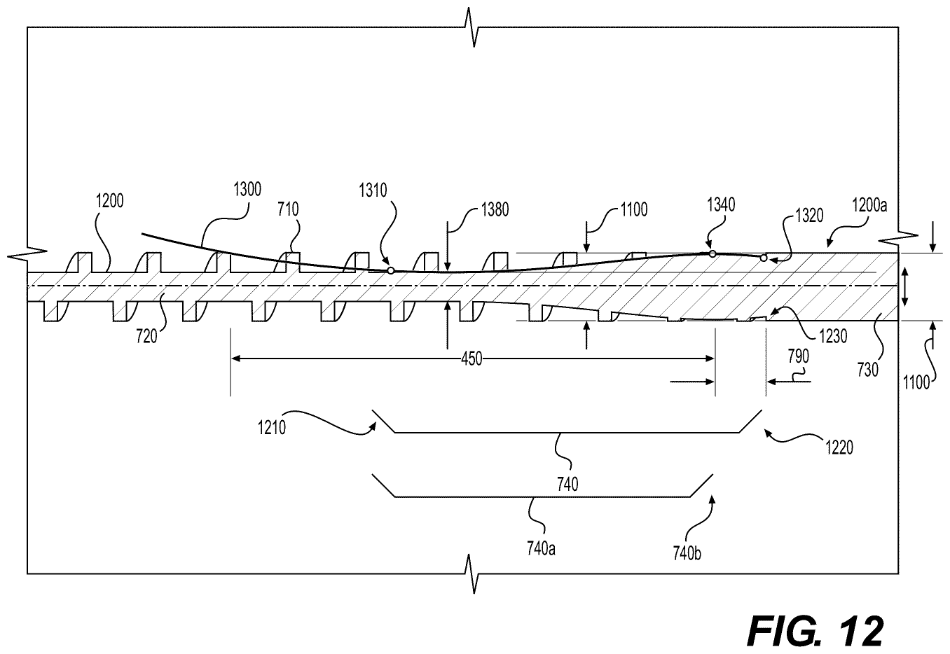

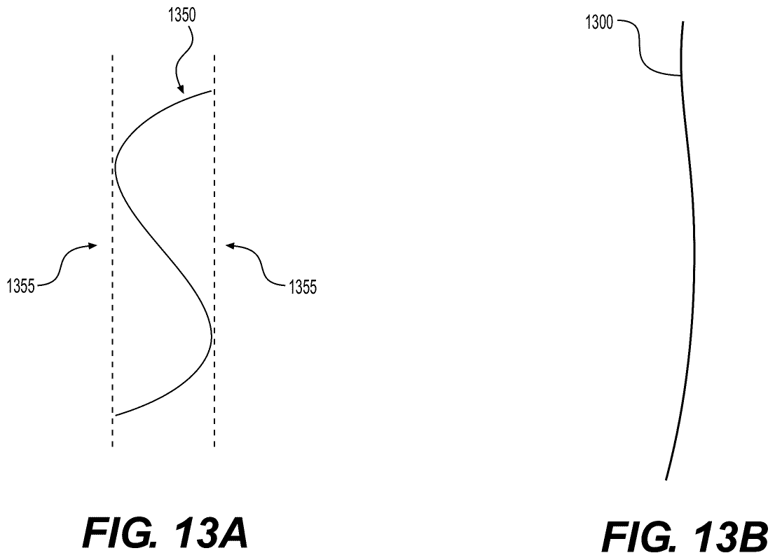

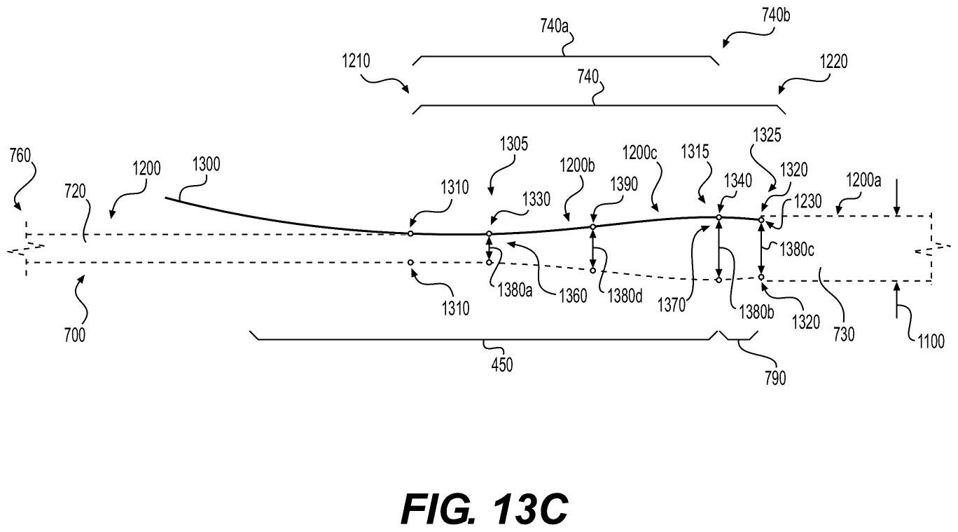

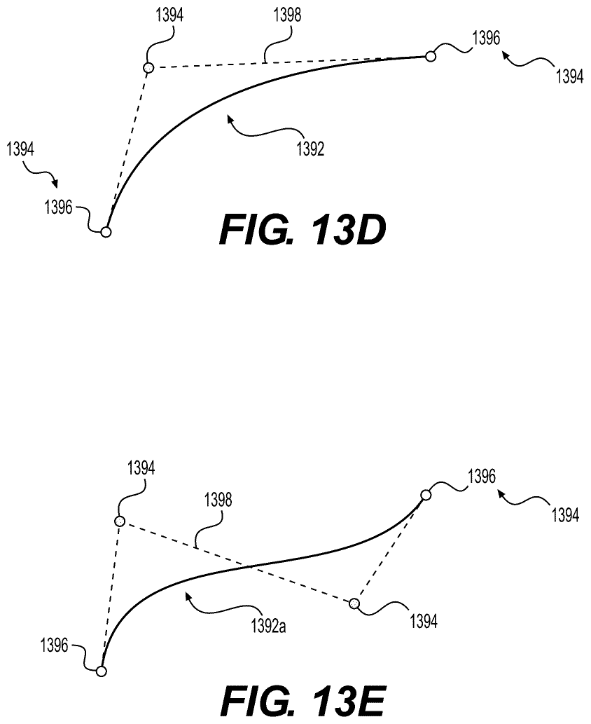

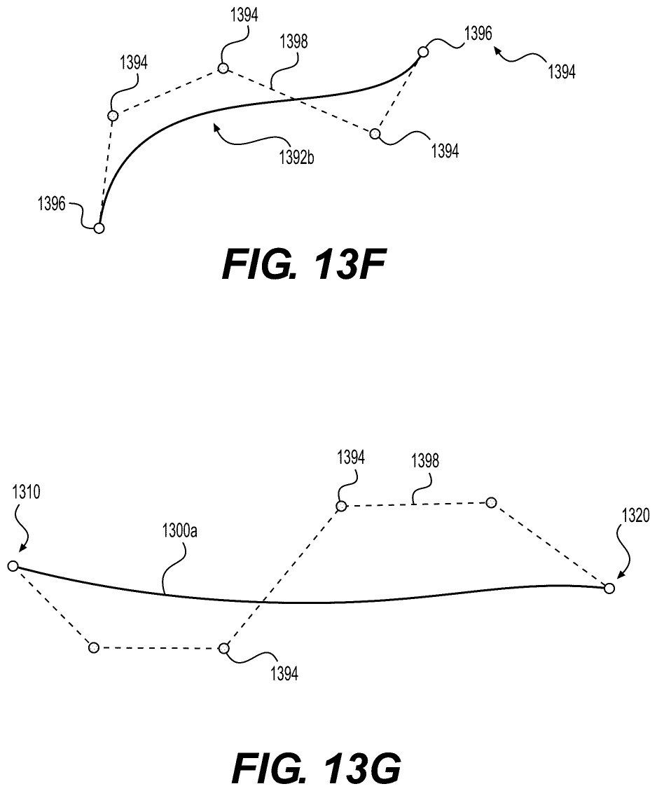

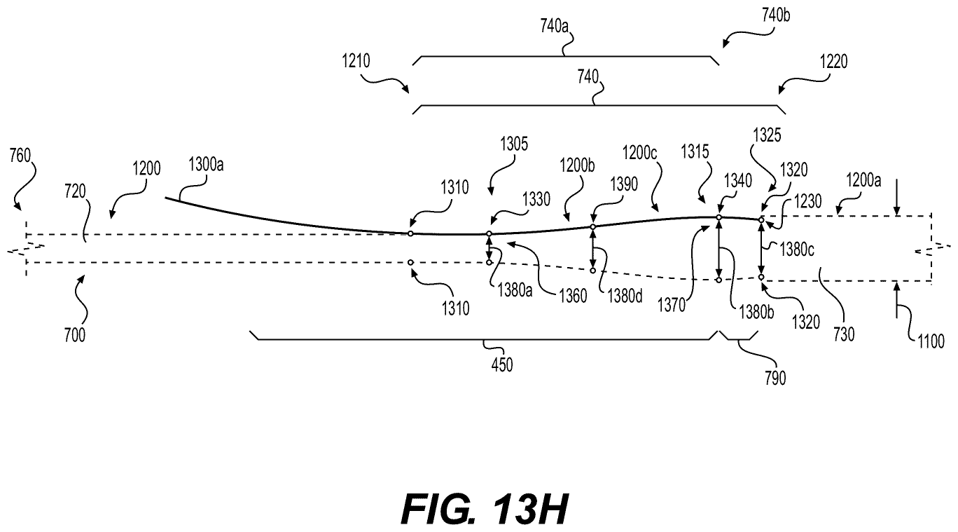

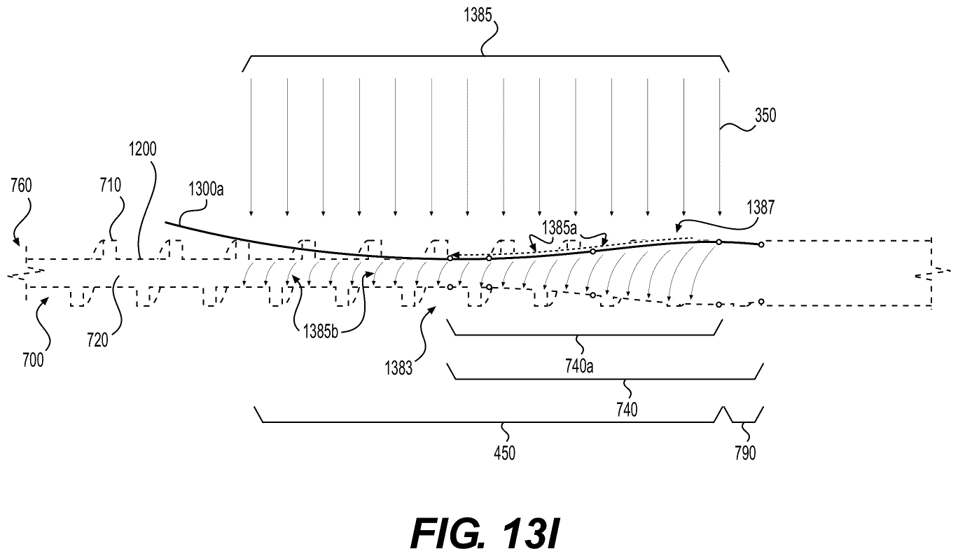

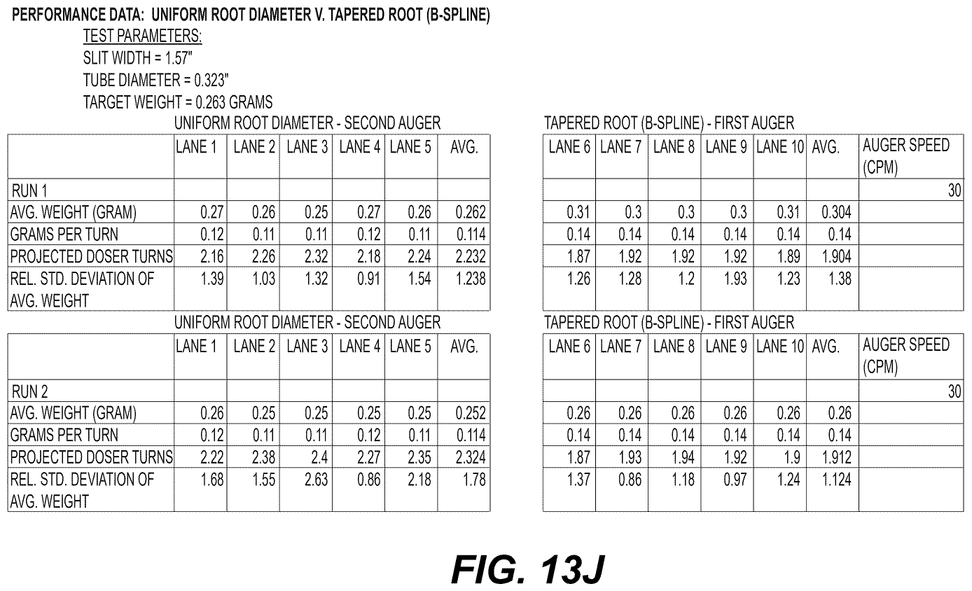

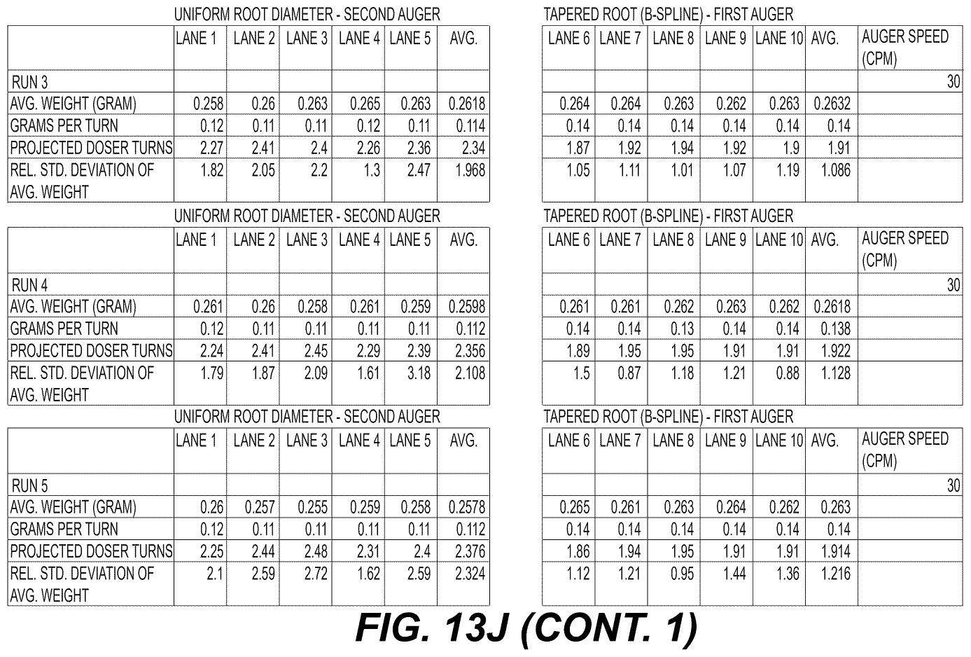

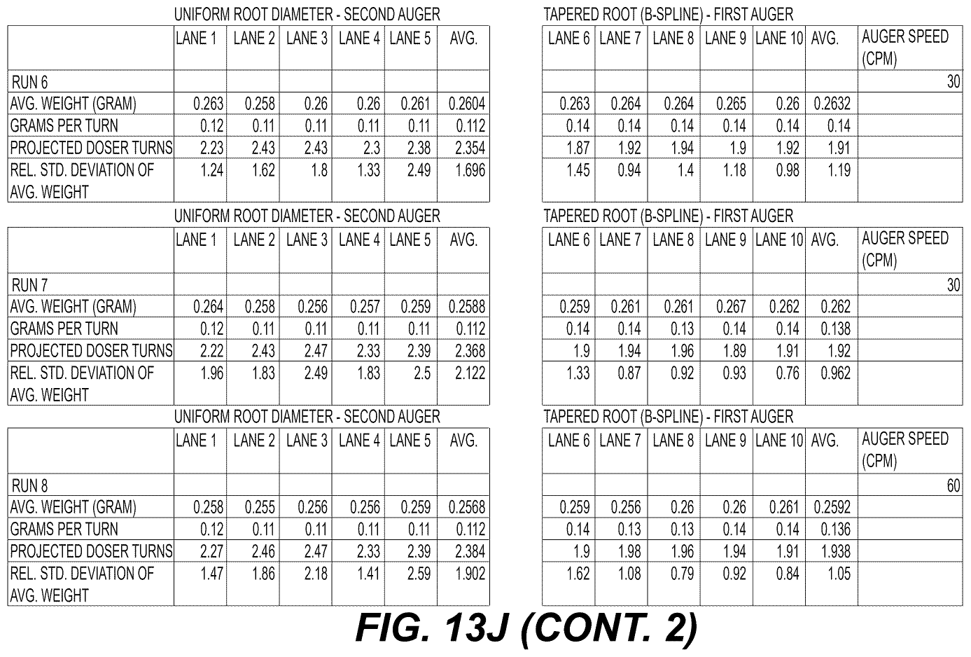

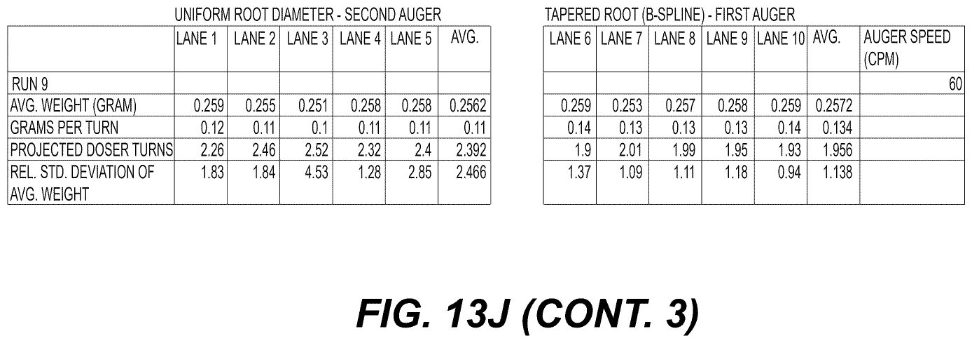

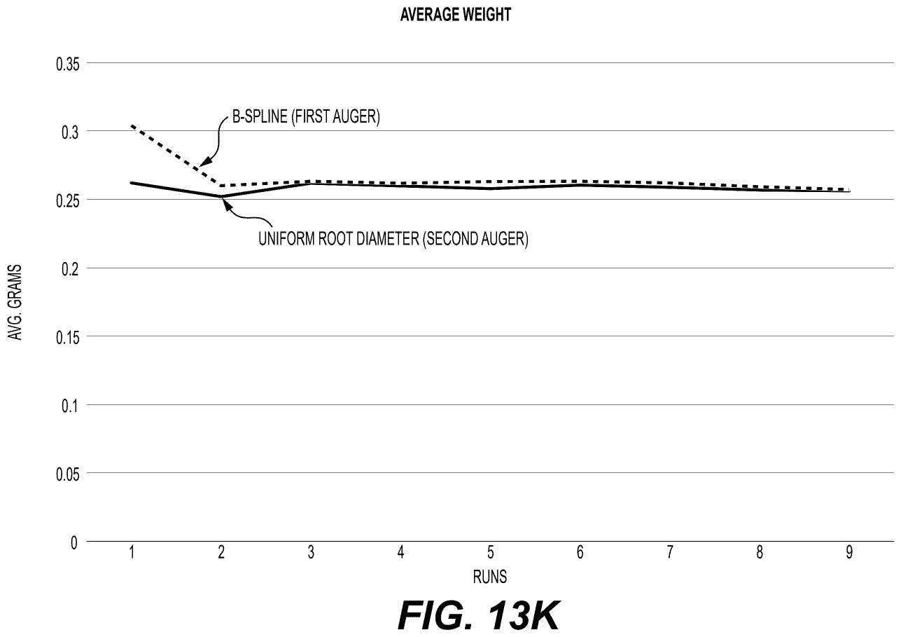

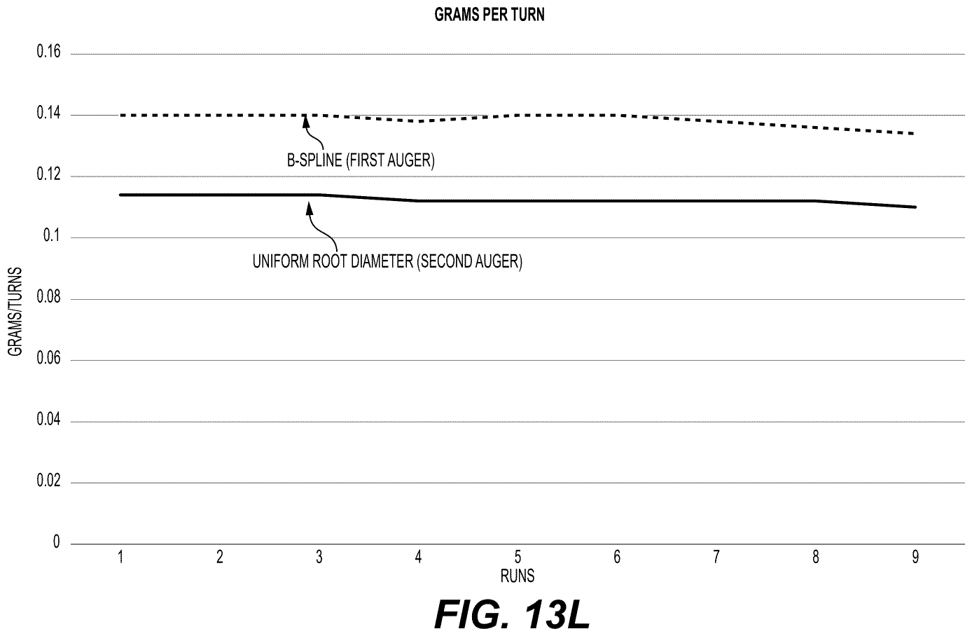

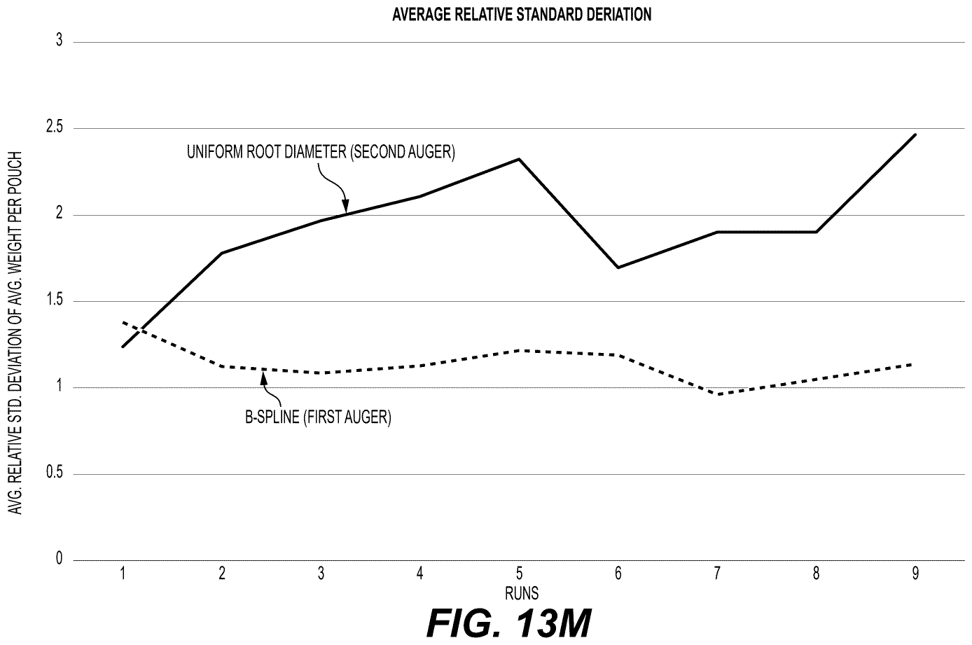

In at least one example embodiment, and as shown in FIG. 11, the external diameter 1100 of the shank 730 is the same as the external diameter 1100 of the flights 710. In at least one example embodiment, the external diameter 1100 is about 0.1 inch to 1 inch, or about 0.2 inch to about 0.5 inch, or about 0.25 inch to 0.4 inch. In at least one example embodiment, the external diameter 1100 is 0.307 inches. In at least one example embodiment, the root diameter 1105 of the root 720 of the non-tapered root section 775 of the drive shaft 745 is the same along the longitudinal length of the non-tapered root section 775. In at least one example embodiment, the root diameter 1105 of the non-tapered root section 775 is about 0.1 inch to 1 inch, or about 0.2 inch to about 0.5 inch, or about 0.2 inch to 0.3 inch. In at least one example embodiment, the root diameter 1105 is 0.177 inches. In at least one example embodiment, the root diameter 1380 of the tapered root section 740 is variable, along a longitudinal length of the tapered root section 740, as described in more detail in relation to FIGS. 12, 13C and 13H.

In at least one example embodiment, a thickness 1115 and a pitch 1120 of the flights 710 is the same across the drive shaft 745. In at least one example embodiment, the thickness 1115 of the flights 710 is about 0.01 inch to 0.10 inch, or about 0.3 inch to 0.7 inch, or about 0.6 inch. In at least one example embodiment, the pitch 1120 is about 0.1 inch to 1 inch, or about 0.2 inch to about 0.5 inch, or about 0.25 inch to 0.4 inch.

In at least one example embodiment, the longitudinal length 780 of the auger 700 is about 5 inches to 5 feet, or about 6 inches to 2 feet, or about 9 inches. In at least one example embodiment, the longitudinal length 795 of the drive shaft 745 is about 2 inches to 3 feet, or about 4 inches to 1 foot, or about 7 inches. In at least one example embodiment, a longitudinal length of the tapered root section 740 is about 1 inch to 1 foot, or about 1.5 inches to 6 inches, or about 2 inches. In at least one example embodiment, a longitudinal length of the non-loading section 790 is about 0.1 inch to 6 inches, or about 0.2 inches to 3 inches or about 0.3 inches.

In at least one example embodiment, the dimensions described herein can be scaled to vary significantly, such that the auger 700 can be used in a system 100 that can be any size between small-scale (bench scale) and large-scale (large industrial). In at least one example embodiment, a relative ratio of the dimensions of the auger 700 can vary significantly. For example, in at least one example embodiment, the longitudinal length of the non-tapered root section 775 may be significantly longer or shorter than the longitudinal length of the tapered root section 740 and/or shank 730.

FIG. 12 is an illustration of a close-up view of a portion of the auger 700 shown in FIG. 11, in accordance with at least one example embodiment. FIG. 13A-13C are illustrations showing a formation of a curved profile 1300 used to define the root 720 of the auger 700, in accordance with at least one example embodiment.

In at least one example embodiment, and as shown in FIG. 12, the curved profile (an imaginary curve) 1300 is shown being superimposed onto the auger 700, where the curved profile 1300 is used to describe a shape of an outer surface 1200 of the root 720 within the tapered root section 740. In at least one example embodiment, a first endpoint 1310 on the curved profile 1300 signifies a point at which the curved profile 1300 intersects with and contacts the outer surface 1200 of the root 720, near a first end 1210 of the tapered root section 740 (also see FIG. 13C). In at least one example embodiment, a second endpoint 1320 on the curved profile 1300 signifies a final point at which the curved profile 1300 contacts the outer surface 1200 of the root 720, near a second end 1220 of the tapered root section 740 (see FIGS. 12 and 13C). In at least one example embodiment, an annular step 1230 is defined between the second endpoint 1320 of the curved profile 1300 and an outer surface 1200a of the shank 730. In at least one example embodiment, all portions of the curved profile 1300, between the first endpoint 1310 and the second endpoint 1320, contact and define the outer surface 1200 of the tapered root section 740 of the root 720 of the auger 700. In at least one example embodiment, the loading portion 740a of the tapered root section 740 is between the first endpoint 1310 and a fourth endpoint 1340. In at least one example embodiment, and as explained in more detail in FIGS. 14 and 15, the loading portion 740a of the tapered root section 740 is a portion of the auger 700 that is expected to be directly loaded by the loading zone 450 of the system 100 (see FIGS. 14 and 15). That is to say, in at least one example embodiment, the loading portion 740a is the portion of the tapered root section 740 that is directly under the slot 460 of the hopper 110 (see FIGS. 14 and 15).

In at least one example embodiment, and as shown in FIG. 13A, a first imaginary curve 1350 is depicted, where the first imaginary curve 1350 is a sinusoidal and/or “S” shaped curve. In at least one example embodiment, by pressing the sides 1355 of the first imaginary curve 1350, the first imaginary curve 1350 is transformed into the curved profile 1300 depicted in FIG. 13B, where the curved profile 1300 is a “flattened S-shaped curve,” or a “flattened sinusoidal curve,” also shown in FIG. 12.

In at least one example embodiment, and as shown in FIG. 13C, the curved profile 1300 is shown superimposed onto the root 720 of the auger 700 to define at least a portion of the outer surface 1200 of the tapered root section 740. In at least one example embodiment, the curved profile 1300 includes a valley 1360 at a third endpoint 1330. In at least one example embodiment, the valley 1360 of the curved profile 1300 causes the outer surface 1200 of the tapered root section 740 to define a first neck 1305 at the third endpoint 1330. In at least one example embodiment, a first diameter 1380a of the first neck 1305 is a minimum diameter of the tapered root section 740, and a smallest diameter of the root 720, along the longitudinal length 780 of the auger 700 (FIG. 8). In at least one example embodiment, the curved profile 1300 further includes a peak 1370 at the fourth endpoint 1340. In at least one example embodiment, the peak 1370 of the curved profile 1300 causes the outer surface 1200 of the tapered root section 740 to define a protruding portion 1315 at the fourth endpoint 1340. In at least one example embodiment, a second diameter 1380b of the protruding portion 1315 at the fourth endpoint 1340 is a maximum diameter of the tapered root section 740, and a largest diameter of the root 720. In at least one example embodiment, the annular step 1230 causes the outer surface 1200 of the root 720 to define a second neck 1325 with a third diameter 1380c at the second endpoint 1320.

In at least one example embodiment, the curved profile 1300 between the first endpoint 1310 and a fifth endpoint 1390 causes a vertical cross-section (FIG. 13C) of the outer surface 1200 of the tapered root section 740 to be in the shape of an arcuate-shaped concave surface 1200b (a “first part” of the of the tapered root section 740). In at least one example embodiment, the curved profile 1300 between the fifth endpoint 1390 and the second endpoint 1320 causes a vertical cross-section (FIG. 13C) of the outer surface 1200 of the tapered root section 740 to be in the shape of an arcuate-shaped convex surface 1200c (a “second part” of the of the tapered root section 740). In at least one example embodiment, the fifth endpoint 1390 is an “inflection point” (transition point), where the vertical cross-section of the outer surface 1200 of the tapered root section 740 changes from being concave to convex, along the longitudinal length 780 of the tapered root section 740.

In at least one example embodiment, the tapered root section 740 causes the particulate material 350 received at the loading zone 450 to be better controlled and more effectively mobilized towards the second end 760 of the auger 700, while a rotational force is applied to the auger 700 and the auger 700 is being actively used within the system 100 (see at least FIGS. 14 and 15). In particular, when the entrance end 480 of the loading zone 450 is aligned with and directly above a front end 740b of the loading portion 740a of the tapered root section 740 (see FIGS. 13C, 14 and 15), the arcuate-shaped convex surface 1200c of the tapered root section 740 (FIG. 13C) causes the particulate material 350 to gradually slide along and down the tapered root section 740, thereby more effectively mobilizing the particulate material 350 toward the second end 760 of the auger 700. Additionally, the arcuate-shaped concave surface 1200b of the tapered root section 740 causes the particulate material 350 to slide down and along the root 720 at an increased rate, relative to the arcuate-shaped convex surface 1200c, as the arcuate-shaped concave surface 1200b causes the particulate material 350 to be more expediently transferred towards the non-tapered root section 775 of the auger 700 without the particulate material 350 becoming “stalled” and clogged within the loading portion 740a of the auger 700. That is to say, in at least one example embodiment, by aligning the protruding portion 1315 of the tapered root section 740 with the entrance end 480 of the loading zone 450, and with the arcuate-shaped concave surface 1200b being directly adjacent to and following the arcuate-shaped convex surface 1200c within the tapered root section 740, the particulate material 350 is more effectively mobilized, thereby allowing the loading zone 450 of the system 100 to evenly load the particulate material 350 onto the auger 700 without experiencing loading problems (such as the problems depicted for instance in FIGS. 4A, 5 and 6).

In at least one example embodiment, the second diameter 1380b of the root 720 at the protruding portion 1315 is about 0.1 inch to 1 inch, or about 0.2 inch to about 0.5 inch, or about 0.25 inch to 0.4 inch. In at least one example embodiment, the second diameter 1380b is 0.304 inches. In at least one example embodiment, the first diameter 1380a of the first neck 1305 is about 0.1 inch to 1 inch, or about 0.2 inch to about 0.5 inch, or about 0.2 inch to 0.3 inch. In at least one example embodiment, the first diameter 1380a is 0.134 inches. In at least one example embodiment, the first diameter 1380a of the first neck 1305 is about half the size of the second diameter 1380b of the protruding portion 1315. In at least one example embodiment, the second diameter 1380b equals the external diameter 1100 of the flights 710 (see FIGS. 12 and 13C). In at least one example embodiment, the second diameter 1380b of the protruding portion 1315 is about 1-10% smaller than the external diameter 1100 of the shank 730 and the flights 710. In at least one example embodiment, the second diameter 1380b is 1% smaller than the external diameter 1100.

In at least one example embodiment, a fourth diameter 1380d of the root 720, at the fifth endpoint (“inflection point”) 1390 is about 0.1 inch to 1 inch, or about 0.2 inch to about 0.5 inch, or about 0.2 inch to 0.3 inch. In at least one example embodiment, the fourth diameter 1380d is 0.177 inches. In at least one example embodiment, the fourth diameter 1380d at the fifth endpoint 1390 is about 40% to 65% the size of the second diameter 1380b at the protruding portion 1315. In at least one example embodiment, the fourth diameter 1380d is 60% the size of the second diameter 1380b.

In at least one example embodiment, the third diameter 1380c of the second neck 1325 of the tapered root section 740 is about 0.1 inch to 1 inch, or about 0.2 inch to about 0.5 inch, or about 0.2 inch to 0.3 inch. In at least one example embodiment, the third diameter 1380c is 0.276 inches. In at least one example embodiment, the third diameter 1380c of the second neck 1325 is about three times the size of the first diameter 1380a of the first neck 1305. In at least one example embodiment, the third diameter 1380c of the second neck 1325 is about twice the size of the first diameter 1380a of the first neck 1305.

FIG. 13D-13G are illustrations showing a formation of a curved profile 1300a used to define an outer surface 1200 of the root 720 of the auger 700, in accordance with at least one example embodiment.

In at least one example embodiment, the outer surface 1200 of the root 720 is a curve derived by a “b-spline function.” The b-spline function is a linear combination of b-splines that can be used for fitting a curve 1392 (see FIG. 13D), as defined for instance by “Definition of a B-Spline Curve,” Department of Computer Science at University of California, Davis, by Kenneth I Joy, 1999, which is incorporated by reference in its entirety into this disclosure. In at least one example embodiment, a shape of the curve 1392 is controlled by a variable number of control points 1394 to form a smooth curve. Usually, only endpoints 1396 of the b-spline function are actually on the curve 1392, where the endpoints 1396 are control points 1394 that defines ends of the curve 1392. The remaining control points 1394, between each of the endpoints 1396, provide a framework 1398 that influences a precise shape of the curve 1392, as described below in more detail.

A spline function of order n is a piecewise polynomial function of degree n−1. A property of spline functions is that the spline functions and their derivatives can be continuous, depending on a multiplicity of “knots” (break points, which are at the locations of the control points 1394). B-splines of order n are basis functions for spline functions of a same order defined over a same number of knots. Meaning, spline functions can be built from linear combinations of B-splines, with one unique combination for each spline function.

A b-spline of order p+1 is a collection of polynomial functions B_{i,p}(t) of degree p in a variable t. Values of t where pieces of the polynomials meet are “knots” that are denoted t₀, t₁, t₂, . . . tₘ that are sorted in non-decreasing order, such that tⱼ≤tⱼ+1. The B-spline contributes only within a range between the first and last of the knots, and is zero elsewhere. If each knot is separated by a same distance (where from its predecessor, the knot vector and the corresponding B-splines are “uniform.”

For a given sequence of knots, there is, up to a scaling factor, a unique spline B_{i,p}(x) satisfying the following equation.

$${B}_{i , p} ( t ) = \{ \begin{matrix}non - zero & if {t}_{i} \leq t < {t}_{i + p + 1} , \\ 0 & otherwise .\end{matrix} \qquad Eq . 1$$

The following additional constraint is added.

$${\sum }_{i = 0}^{m - p - 1} {B}_{i , p} ( t ) = 1 \qquad Eq . 2$$

For all t between knots tₚ and tₘ₋ₚ, the scaling factor of B_{i,p}(t) becomes fixed. Knots that are in-between, and are not including tₚ and tm-p, are called “internal knots.”

B-splines are constructed by a Cox-de Boor recursion formula. Using a piecewise constant polynomial, B-splines start with degree p=0 using the equation below.

$${B}_{i , 0} ( t ) := \{ \begin{matrix}1 & if {t}_{i} \leq t < {t}_{i + 1} , \\ 0 & otherwise .\end{matrix} \qquad Eq . 3$$

The higher degree b-splines, for p+1, are defined by recursion as indicated in the following equation.

$${B}_{i , p} ( x ) := \frac{t - {t}_{i}}{{t}_{i + p} - {t}_{i}} {B}_{i , p - 1} ( t ) + \frac{{t}_{i + p + 1} - t}{{t}_{i + p + 1} - {t}_{i + 1}} {B}_{i + 1 , p - 1} ( t ) . \qquad Eq . 4$$

For each finite knot interval that is non-zero, a b-spline is a polynomial of degree n−1. A b-spline is a continuous function at the knots. When all knots belonging to the B-spline are distinct, its derivatives are continuous up to the derivative of degree n−2. If the knots are coincident at a given value of x, the continuity of derivative order is reduced by 1 for each additional coincident knot. B-splines may share a subset of their knots, but two B-splines defined over the same knots are identical. In other words, a B-spline is uniquely defined by the knots.

Internal knots (at the control point 1394 locations between the endpoints 1396) are distinguishable from the endpoints 1396. Internal knots cover the x-domain. Since a single B-spline extends over 1+n knots, the internal knots are extended with n−1 endpoints on each side, to give full support to a first and last b-spline, which affects internal knot intervals.

Any spline function of order n on a given set of knots can be expressed as a linear combination of b-splines, using the equation below:

$${S}_{n , t} ( x ) = {\sum }_{i} {α}_{i} {B}_{i , n} ( x ) . \qquad Eq . 5$$

Expressions for the polynomial pieces of a b-spline can be derived by means of the Cox-de Boor recursion formula.

$${B}_{i , 0} ( x ) := \{ \begin{matrix}1 & if {L}_{i} \leq x < {t}_{i + 1} , \\ 0 & otherwise .\end{matrix} \qquad Eq . 6$$

$${B}_{i , k} ( x ) := \frac{x - {t}_{i}}{{t}_{i + k} - {t}_{i}} {B}_{i , k - 1} ( x ) + \frac{{t}_{i + k + 1} - x}{{t}_{i + k + 1} - {t}_{i + 1}} {B}_{i + 1 , k - 1} ( x ) . \qquad Eq . 7$$

That is, B_{j,0}(x) is a piecewise constant of one or zero indicating which knot span x is in (zero if the knot span j is repeated). The recursion equation is listed below.

$$\frac{x - {t}_{i}}{{t}_{i + k} - {t}_{i}} \qquad Eq . 8$$

Ramps from zero to one, as x goes from tᵢ to tᵢ₊ₖ, are indicated in this equation.

$$\frac{{t}_{i + k + 1} - x}{{t}_{i + k + 1} - {t}_{i + 1}} \qquad Eq . 9$$

Ramps are from one to zero, as x goes from tᵢ₊₁ to tᵢ₊ₖ₊₁. Corresponding Bs are zero outside these respective ranges. For example, B_{i,j}(x) is a triangular function that is zero below x=tᵢ, ramps to one at x=tᵢ₊₁ and back to zero at and beyond x=tᵢ₊₂. However, because B-spline basis functions have local support, b-splines can be computed by algorithms that do not need to evaluate basis functions when they are zero.

As shown in FIGS. 13E-G, by further adding control points 1394 (“knots” between the endpoints 1396) to the framework 1398, the curve 1392 that is derived by the associated b-spline functions may vary in complexity. In at least one example embodiment, by using between four and six control points 1394 (or, more than six control points) as shown in FIGS. 13E-G, a resulting b-spline curve can be formed into a curve with similar properties as the curved profile 1300 of FIG. 13C. Specifically, in at least one example embodiment, by using four control points 1394 (FIG. 13E), five control points 1394 (FIG. 13F), or six control points 1394, the resulting b-spline functions can be used to form the curves 1392a, 1392b and 1300a, each of which are “flattened sinusoidal curves,” with properties that can be similar to the curved profile 1300 of FIG. 13C, as explained for example in relation to FIG. 13H, below.

FIG. 13H is an illustration showing the curved profile 1300a superimposed onto the tapered root section 740 of the auger 700, in accordance with at least one example embodiment. FIG. 13I is an illustration showing a travel path of the particulate material 350 flowing across and down the curved profile 1300a of the tapered root section 740 of the auger 700, in accordance with at least one example embodiment.

In at least one example embodiment, at least a portion of the curved profile 1300a which is formed by b-spline functions (see FIG. 13G), or at least a portion of the curves 1392a/1392b that are flattened sinusoidal curves formed by b-spline functions with at least four control points 1394, can be superimposed onto the root 720 of the auger 700 to define a shape of the outer surface 1200 of the tapered root section 740. In at least one example embodiment, the curved profile 1300a of FIG. 13H shares dimensional properties that are described above in relation to the curved profile 1300 of FIG. 13C. In particular, and in at least one example embodiment, the curved profile 1300a defines the tapered root section 740 such that the front end 740b of the loading portion 740a of the auger 700 includes the protruding portion 1315 that is along the arcuate-shaped convex surface 1200c on the second end 1220 (“leading end”) of the tapered root section 740, with the arcuate-shaped concave surface 1200b directly abutting the arcuate-shaped convex surface 1200c and being on the first end 1210 (“lagging end”) of the tapered root section 740. In at least one example embodiment, the curved profile 1300a includes the fifth endpoint 1390 located between the third endpoint 1330 and the fourth endpoint 1340, where the fifth endpoint 1390 is an “inflection point” (transition point) between the arcuate-shaped convex surface 1200c and the arcuate-shaped concave surface 1200b. In at least one example embodiment, the curved profile 1300a includes a first neck 1305, where the first diameter 1380a of the first neck 1305 is a minimum diameter of the root 720. In at least one example embodiment, the curved profile 1300a defines the second neck 1325 at the second end 1220 of the tapered root section 740. In at least one example embodiment, the other dimensional parameters which are described in relation to the curved profile 1300 of FIG. 13C apply equally to the curved profile 1300a of FIG. 13H.

In at least one example embodiment, and as shown in FIG. 13I, when the auger 700 is installed in the system 100 with the front end 740b of the loading portion 740a aligned with the entrance end 480 the loading zone 450 of the hopper 110 (see FIG. 14), the hopper 110 will “flood load” the loading portion 740a (see FIG. 15) when the system 100 is in operational use. In at least one example embodiment, during the “flood loading,” flow streams 1385 of the particulate material 350 settle onto an upper part 1387 of the loading portion 740a of the auger 700, as the auger 700 rotates and the flights 710 mobilize the particulate material towards the second end 760 of the auger 700. In at least one example embodiment, secondary streams 1385a of some of the particulate material 350 travel along the upper part 1387 of the loading portion 740a and towards the second end 760, and tertiary streams 1385b of some of the particulate material 350 fall along sides of the auger 700 and settle near a lower end 1383 of the auger 700. In at least one example embodiment, the curved profile 1300 (of FIG. 12) likewise causes the secondary streams 1385a and tertiary streams 1385b of the particulate material 350 to mobilize the particulate material 350 toward the second end 760 and allow the particulate material 350 to settle along the lower end 1383 of the auger 700.

In at least one example embodiment, the curved profile 1300 (FIG. 12) and/or the curved profile 1300a (FIG. 13I) of the outer surface 1200 of the tapered root section 740 allows the secondary streams 1385a and the tertiary streams 1385b of the particulate material 350 to gracefully and effectively slide along the outer surface 1200 (as shown in FIG. 13I), to reduce clogging, bridging and/or rat-holing of the particulate material 350 in the loading zone 450 of the system 100 (see FIGS. 14 and 15). In at least one example embodiment, this improved movement of the particulate material 350 along the outer surface 1200 of the auger 700 ensures that the level 400 in the hopper 110 remains fairly flat (see the level 400 of FIG. 15, contrasted with the level 400 that is uneven in FIG. 4A). In at least one example embodiment, this improved movement of the particulate material 350 also ensures that the auger 700 can provide a volumetric rate of movement of the particulate material 350 that is better controlled. Especially when the system 100 (FIG. 15) is operating at high speeds, this can ensure that a more consistent amount of the particulate material 350 can be included in consumer products made from the particulate material 350.

FIGS. 13J and 13M depict experimental data for the curved profiles, in accordance with at least one example embodiment.

In at least one example embodiment, and as shown in performance test data that is tabulated in FIG. 13J, a first auger with an outside diameter of 0.3125 inches and a tapered root with a root diameter of 0.177 inches formed via the curved profile 1300a (formed via a B-spline function) was tested in conjunction with a second auger with an outside diameter of 0.3125 inches that has a uniform root diameter with a root diameter of 0.177 inches. Specifically, FIG. 13J depicts nine separate runs, with lanes 1-5 listing the performance of the second auger, and lanes 6-10 listing the performance of the first auger. The test involved distributing a dry powder with a particle size range of 10 micrometers to 1.44 mm into pouches, where the target weight per pouch was 0.263 grams of the powder. FIG. 13K is a diagram depicting an average weight per pouch for each of the runs of the first auger and the second auger. FIGS. 13L and 13M are diagrams depicting the grams per turn and an average relative standard deviation, respectively, for the first auger and the second auger. Overall, runs 1-9 indicated a higher downstream speed with a more even flow of the powder, and reduced blocking, ratholes, and jamming for the first auger, relative to the second auger.

As depicted in FIG. 13L, the first auger displayed a higher grams per turn, even at higher auger speeds (runs 1-7 used auger speeds at 30 cycles per minute, and runs 8-9 used auger speeds at 60 cycles per minute). As in FIG. 13J, a projected number of turns to distribute the target weight per pouch was consistently lower for the first auger. In at least one example embodiment, a reduction in wear, damage and/or replacement of the auger 700 is therefore anticipated, relative to augers with a uniform root diameter.

As depicted in FIG. 13M, the first auger has an average relative standard deviation of the average weight per pouch that is lower, and overall more steady, relative to the second auger. In at least one example embodiment, a consistent amount of distribution of the powder of the auger 700 is therefore anticipated, relative to augers with a uniform root diameter.

FIGS. 14-15 are illustrations of a conveying system, in accordance with at least one example embodiment.

In at least one example embodiment, the auger 700 is installed into the conveying system 100, such that the tapered root section 740 is at least partially aligned with and directly under the loading zone 450. In at least one example embodiment, the tapered root section 740 is shorter than the loading zone 450. In at least one example embodiment, at least the loading portion 740a of the tapered root section 740 is aligned with and at least partially underneath the loading zone 450 of the system 100. In at least one example embodiment, a front end 740b of the loading portion 740a of the tapered root section 740 is aligned and directly under the entrance end 480 of the loading zone 450 of the system 100. In at least one example embodiment, the front end 740b of the loading portion 740a includes the fourth endpoint 1340 of the curved profiles 1300 and 1300a (FIGS. 13C and 13H), where the front end 740b of the loading portion 740a is aligned with the entrance end 480 of the loading zone 450. In at least one example embodiment, the non-loading section 790 of the auger 700 is not directly under the loading zone 450 of the system 100. In at least one example embodiment, the non-loading section 790 is positioned between the entrance end 480 of the loading zone 450 and an endplate 120a of the first conveying tube 120. In at least one example embodiment, the non-tapered root section 775 is positioned below and/or downstream of the exit end 470 of the loading zone 450 of the system 100. In at least one example embodiment, at least a portion of the non-tapered root section 775 is positioned under the exit end 470 of the loading zone 450, where the non-tapered root section 775 extends underneath 20% of the length of the loading zone 450, or about 30% of the length of the loading zone 450, or about 40% of the length of the loading zone 450, while the loading portion 740a is underneath a remaining portion of the loading zone 450.

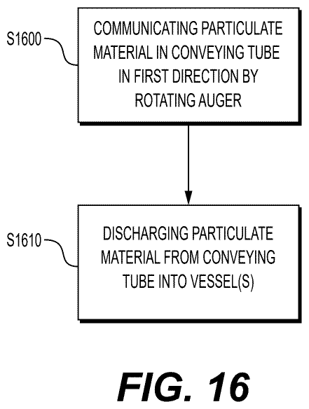

FIG. 16 is an illustration of method steps for a method of filling vessels, in accordance with at least one example embodiment.

In at least one example embodiment, and as shown in step S1600, the particulate material 3500 is conveyed through the conveying tube(s) 120 and/or 130 by rotating the auger 700 (see at least FIGS. 1 and 15). In at least one example embodiment, and as shown in step S1610, the particulate material 350 is discharged into one or more vessels at the discharge point of the conveying tube(s) 120 and/or 130.

In at least one example embodiment, the one or more vessels include a pouch. In at least one example embodiment, the one or more vessels include a container, box, compartment, bag, bowl, cask, or another type of structure for containing a powder and/or a filler. In at least one example embodiment, the one or more vessels are structures or material for containing consumer products, which may be referred to as “consumer containers.”

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

What is claimed is:

1. An auger, comprising:
a root in the shape of a first cylindrically-shaped post, a first section of the root having a variable diameter along a first longitudinal length of the first section, a second section of the root having a first uniform diameter along a second longitudinal length of the second section; and
flights extending from the root, the flights being helically wound around the root along a third longitudinal length of the root.

2. The auger of claim 1, wherein the flights have a pitch and a first external diameter that is uniform along the third longitudinal length of the root.

3. The auger of claim 1, further comprising;
a shank connected to the first section, the shank having an outer surface that is substantially smooth and is in the shape of a second cylindrically-shaped post with a second uniform diameter along a fourth longitudinal length of the shank, a first longitudinal centerline of the shank and a second longitudinal centerline of the root being collinearly aligned.

4. The auger of claim 3, wherein the flights have a first external diameter that is equal to a second external diameter of the shank.

5. The auger of claim 1, wherein the first section of the root includes
a first part with a first vertical cross-section that includes arcuate-shaped concave outer surfaces, and
a second part with a second vertical cross-section that includes arcuate-shaped convex outer surfaces, the first part being between and directly connected to the second part and the second section.

6. The auger of claim 5, wherein an outer surface of the root includes a first neck that is between a first transition and a second transition, the first transition being at a first interface between the first section and the second section, the second transition being at a second interface between the first part and the second part.

7. The auger of claim 6, wherein the first neck has a first diameter that is a smallest diameter of root, the auger further comprising:
a shank connected to the first section of the root, wherein the root includes a second neck on a third end of the second part, the third end being directly connected to the shank, the second neck having a second diameter that is larger than the first diameter, and
wherein the shank has a first outer surface that is substantially smooth and is in the shape of a second cylindrically-shaped post with a second uniform diameter along a fourth longitudinal length of the shank, a first longitudinal centerline of the shank and a second longitudinal centerline of the root being collinearly aligned.

8. The auger of claim 6, wherein
the root includes a protrusion with a first diameter, the protrusion being within the second part, the first diameter being a largest diameter of the root, and
the root at the second transition has a second diameter that is between 40% and 65% that of the first diameter,
the first neck has a third diameter that is a smallest diameter of root, the third diameter being half the size of the first diameter, and
the flights has a first external diameter that is equal to the first diameter.

9. The auger of claim 5, wherein the first part and the second part are in the shape of a flattened sinusoidal curve.

10. The auger of claim 5, wherein the first part and the second part are in the shape of a curve that is formed by b-spline functions.

11. A system, comprising:
at least one first conveying tube;
the auger of claim 1, the auger being within the at least one first conveying tube; and
a hopper with a loading zone in communication with the at least one first conveying tube, the first section of the root being at least partially aligned with and directly underneath the loading zone.

12. A method of filing vessels, comprising:
communicating particulate material in at least one first conveying tube in a first direction by rotating an auger in the at least one first conveying tube in a first rotational direction; and
discharging the particulate material from the at least one first conveying tube into one or more vessels at a discharge point of the at least one first conveying tube,
the auger including
a root in the shape of a first cylindrically-shaped post, a first section of the root having a variable diameter along a first longitudinal length of the first section, a second section of the root having a first uniform diameter along a second longitudinal length of the second section, the second section extending away from the first section in the first direction, and
flights extending from the root, the flights being helically wound around the root along a third longitudinal length of the root.

13. The method of claim 12, wherein the one or more vessels includes a plurality of pouches.

14. The method of claim 12, wherein the flights have a pitch and a first external diameter that is uniform along the third longitudinal length of the root.

15. The method of claim 12, further comprising:
configuring the auger such that the first section of the root includes
a first part with a first vertical cross-section that includes arcuate-shaped concave outer surfaces, and
a second part with a second vertical cross-section that includes arcuate-shaped convex outer surfaces, the first part being between and directly connected to the second part and the second section.

16. The method of claim 15, wherein
the configuring configures such that an outer surface of the root includes a first neck that is between a first transition and a second transition, the first transition being at a first interface between the first section and the second section, the second transition being at a second interface between the first part and the second part,
the configuring configures such that the first neck has a first diameter that is a smallest diameter of root,
the configuring configures such that a shank is connected to the first section of the root, wherein the root includes a second neck on a third end of the second part, the third end being directly connected to the shank, the second neck having a second diameter that is larger than the first diameter,
the configuring configures such that the shank has a first outer surface that is substantially smooth and is in the shape of a second cylindrically-shaped post with a second uniform diameter along a fourth longitudinal length of the shank, a first longitudinal centerline of the shank and a second longitudinal centerline of the root being collinearly aligned, and
the configuring configures such that a second outer surface of the auger defines a step between the second neck and the shank.

17. The method of claim 15, wherein the configuring configures such that the first part and the second part are in the shape of a curve that is formed by b-spline functions using at least four control points.

18. The method of claim 12, wherein
the particulate material includes a powder,
the powder includes at least one active ingredient, and
the at least one active ingredient includes tobacco-derived nicotine, the at least one active ingredient being in a pure form or a salt form.

19. The method of claim 18, wherein the powder includes at least one excipient, the at least one excipient including a non-dissolvable filler material, the non-dissolvable filler material including microcrystalline cellulose.

20. A method of communicating particulate material, comprising:
communicating particulate material in a conveying tube in a first direction by rotating an auger in the conveying tube in a first rotational direction,
the auger including
a root in the shape of a first cylindrically-shaped post, a first section of the root having a variable diameter along a first longitudinal length of the first section, a second section of the root having a first uniform diameter along a second longitudinal length of the second section, the second section extending away from the first section in the first direction, and
flights extending from the root, the flights being helically wound around the root along a third longitudinal length of the root.
